(19) United States
(12) Patent Application Publication
(10) Pub. No.: US 2025/0216946 A1
(43) Pub. Date: Jul. 3, 2025

(54) DATA PROCESSING METHOD FOR HAPTICS MEDIA AND RELATED DEVICE

(71) Applicant: Tencent Technology (Shenzhen) Company Limited, Shenzhen (CN)

(72) Inventor: Ying HU, Shenzhen (CN)

(21) Appl. No.: 19/087,280

(22) Filed: Mar. 21, 2025

Related U.S. Application Data
(63) Continuation of application No. PCT/CN2024/073295, filed on Jan. 19, 2024.

(30) Foreign Application Priority Data
Feb. 3, 2023 (CN) 202310125653.1

(51) Int. Cl. G06F 3/01

(52) U.S. Cl. CPC G06F 3/016

(57) ABSTRACT

Embodiments of this application provide a method for processing haptics media by a computer device. The method includes: obtaining a media file of reusable haptics media including a bitstream of the reusable haptics media and presentation indication information of the reusable haptics media; and performing decoding processing on the bitstream of the reusable haptics media based on the presentation indication information of the reusable haptics media, to present the reusable haptics media. The embodiments of this application can support encapsulation, indication, and presentation of the reusable haptics media, and improve a presentation effect of the reusable haptics media.

### CROSS-REFERENCE TO RELATED APPLICATIONS

This application is a continuation application of PCT Patent Application No. PCT/CN2024/073295, entitled “DATA PROCESSING METHOD FOR HAPTICS MEDIA AND RELATED DEVICE” filed on Jan. 19, 2024, which claims priority to Chinese Patent Application No. 202310125653.1, entitled “DATA PROCESSING METHOD FOR HAPTICS MEDIA AND RELATED DEVICE” filed with the China National Intellectual Property Administration on Feb. 3, 2023, all of which are incorporated herein by reference in their entirety.

### FIELD OF THE TECHNOLOGY

This application relates to the field of audio and video technologies, and specifically, to a data processing method for haptics media, a data processing apparatus for haptics media, a computer device, a computer-readable storage medium, and a computer program product.

### BACKGROUND OF THE DISCLOSURE

With continuous development of immersive media, in addition to conventional visual and auditory presentation, presentation manners of the immersive media further include new presentation manners such as haptics, for example, vibrotactile and electrotactile. It is found in practice that a current encoding/decoding technology for haptics media still has some technical problems that urgently need to be resolved. For example, some specific content in the haptics media is repeatedly presented, and this type of haptics media may be referred to as reusable haptics media. However, the existing encoding/decoding technology for the haptics media does not provide corresponding encapsulation and transmission technical support of the reusable haptics media, resulting in a relatively poor presentation effect of the reusable haptics media. Therefore, how to improve the encoding/decoding technology for the haptics media to present the reusable haptics media becomes a problem that urgently needs to be resolved.

### SUMMARY

Embodiments of this application provide a data processing method for haptics media and a related device, to support encapsulation, indication, and presentation of reusable haptics media, and improve a presentation effect of the reusable haptics media.

According to an aspect, an embodiment of this application provides a for processing haptics media performed by a computer device, including:
obtaining a media file of reusable haptics media including a bitstream of the reusable haptics media and presentation indication information of the reusable haptics media; and
performing decoding processing on the bitstream of the reusable haptics media based on the presentation indication information of the reusable haptics media, to present the reusable haptics media.

According to an aspect, an embodiment of this application provides a for processing haptics media performed by a service device, including:
performing encoding processing on reusable haptics media, to obtain a bitstream of the reusable haptics media;
adding presentation indication information of the reusable haptics media to the bitstream; and
performing encapsulation processing on the bitstream of the reusable haptics media and the presentation indication information of the reusable haptics media, to obtain a media file of the reusable haptics media.

According to an aspect, an embodiment of this application provides a data processing apparatus for haptics media, including:
an obtaining unit, configured to obtain a media file of reusable haptics media including a bitstream of the reusable haptics media and presentation indication information of the reusable haptics media; and
a processing unit, configured to perform decoding processing on the bitstream of the reusable haptics media based on the presentation indication information of the reusable haptics media, to present the reusable haptics media.

According to an aspect, an embodiment of this application provides a data processing apparatus for haptics media, including:
an encoding unit, configured to perform encoding processing on reusable haptics media, to obtain a bitstream of the reusable haptics media; and
a processing unit, configured to add presentation indication information of the reusable haptics media to the bitstream, where
the processing unit is further configured to perform encapsulation processing on the bitstream of the reusable haptics media and the presentation indication information of the reusable haptics media, to obtain a media file of the haptics media.

According to an aspect, an embodiment of this application provides a computer device, including:
a processor, being adapted to execute a computer program; and
a computer-readable storage medium, having a computer program stored therein, the computer program, when executed by the processor, implementing the data processing method for haptics media as described above.

According to an aspect, an embodiment of this application provides a non-transitory computer-readable storage medium, having a computer program stored therein, the computer program, when executed by a processor of a computer device, causing the computer device to perform the method for processing haptics media as described above.

In the embodiments of this application, a decoder side (a consumption device) of the haptics media may obtain the media file of the haptics media, the haptics media includes the reusable haptics media, and the media file includes the bitstream of the haptics media and the presentation indication information of the reusable haptics media; and perform decoding processing on the bitstream according to the presentation indication information of the knowledge haptics signal to present the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

### BRIEF DESCRIPTION OF THE DRAWINGS

FIG. 1A is a schematic diagram of 6DoF according to an exemplary embodiment of this application.

FIG. 1B is a schematic diagram of 3DoF according to an exemplary embodiment of this application.

FIG. 1C is a schematic diagram of 3DoF+ according to an exemplary embodiment of this application.

FIG. 2A is an architecture diagram of a data processing system for haptics media according to an exemplary embodiment of this application.

FIG. 2B is a flowchart of a data processing method for haptics media according to an exemplary embodiment of this application.

FIG. 3 is a schematic flowchart of a data processing method for haptics media according to an exemplary embodiment of this application.

FIG. 4 is a schematic flowchart of a data processing method for haptics media according to another exemplary embodiment of this application.

FIG. 5 is a schematic diagram of a structure of a data processing apparatus for haptics media according to an exemplary embodiment of this application.

FIG. 6 is a schematic diagram of a structure of a data processing apparatus for haptics media according to another exemplary embodiment of this application.

FIG. 7 is a schematic diagram of a structure of a computer device according to an exemplary embodiment of this application.

### DESCRIPTION OF EMBODIMENTS

### 1. Immersive Media

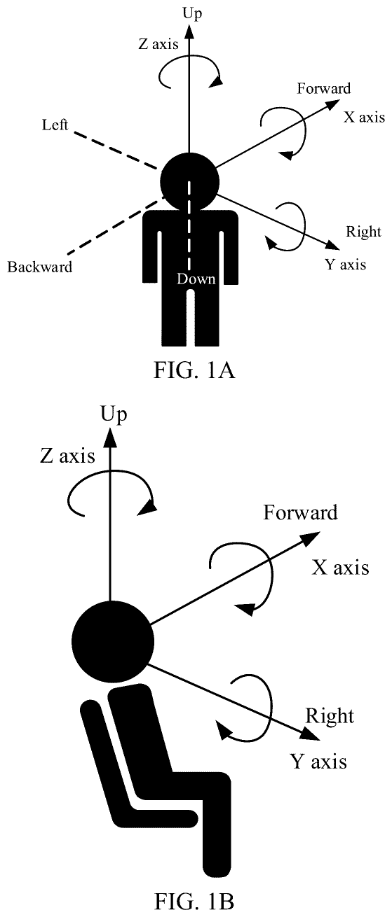

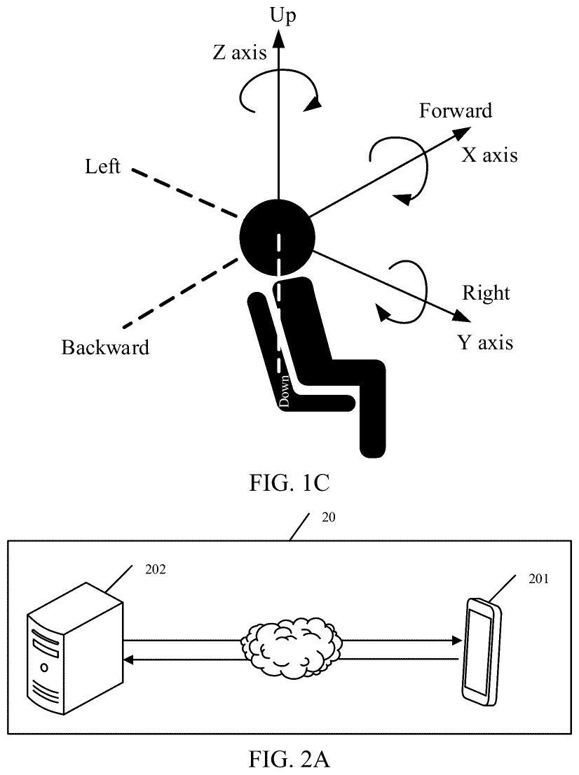

The immersive media refers to a media file that can provide immersive media content, so that a consumer immersed in the media content can obtain a visual experience, an auditory experience, a haptics experience, or the like in the real world. The immersion media may include, but is not limited to, at least one of the following: audio media, video media, haptics media, and the like. The consumer may include, but is not limited to, at least one of the following: a listener of the audio media, a viewer of the video media, a user of the haptics media, and the like. The immersive media may be divided into 6 degree of freedom (6DoF) immersive media, 3DoF immersive media, and 3DoF+ immersive media according to a degree of freedom of the consumer when consuming the media content. As shown in FIG. 1A, the 6DoF means that the consumer of the immersive media may freely translate along an X axis, a Y axis, and a Z axis. For example, the consumer of the immersive media may freely walk in three-dimensional and 360-degree VR content. Similar to the 6DoF, there are also 3DoF and 3DoF+ manufacturing technologies. FIG. 1B is a schematic diagram of 3DoF according to an embodiment of this application. As shown in FIG. 1B, the 3DoF means that a consumer of immersive media is fixed at a center point of a three-dimensional space, and a head of the consumer of the immersive media rotates along an X axis, a Y axis, and a Z axis to view an image provided by media content. FIG. 1C is a schematic diagram of 3DoF+ according to an embodiment of this application. As shown in FIG. 1C, the 3DoF+ means that when a virtual scene provided by immersive media has depth information, a head of a consumer of the immersive media may move in a limited space based on 3DoF to view an image provided by the media content.

### 2. Haptics

Immersive media content is usually presented by using various intelligent devices, such as a wearable device or an interactive device. Therefore, in addition to conventional visual presentation and auditory presentation, presentation manners of the immersive media further include a new presentation manner such as haptics. The haptics allows, through a haptics presentation mechanism combining hardware and software, a consumer to receive information through a body of the consumer, provides an embedded physical feeling, and transfers key information of a system that is being used by the consumer. For example, a device vibrates to remind the consumer of the device that a piece of information is received. Such vibration is a presentation form of haptics. The haptics may further enhance auditory presentation and visual presentation, thereby improving consumer experience.

The haptics may include, but is not limited to, one or more of the following: vibrotactile, kinematic haptics, and electrotactile. The vibrotactile refers to simulating vibration of a specific frequency and intensity through vibration of a motor of a device. For example, in a shooting game, a particular effect when a shooting tool is used is simulated through vibration. The kinematic haptics means that a weight or a pressure of an object is simulated in a kinematic haptics system, and the kinematic haptics may include, but is not limited to, a speed and an acceleration. For example, in a driving game, when a relatively heavy vehicle is moved or is operated at a relatively high speed, a steering wheel may resist rotation. This type of feedback directly affects a consumer. In the example of the driving game, the consumer needs to apply a greater force to obtain a needed response from the steering wheel. In the electrotactile, haptics stimulation is provided for nerve endings of the consumer by using an electric impulse. The electrotactile can create a highly realistic experience for a consumer wearing a suit or gloves equipped with an electrotactile technology. Almost any feeling can be simulated by using the electric pulse, for example, a temperature change, a pressure change, a humidity feeling, and the like. With the popularization of wearable devices and interactive devices, haptics sensed by the consumer when consuming the immersive media content may include omni-directional somatosensation such as vibration, a pressure, a speed, an acceleration, a temperature, humidity, and smell, which is more approximate to real-world haptics presentation experience.

### 3. Haptics Media

the haptics media refers to immersive media whose media type is a haptics type, and is a media file that can provide a consumer with sensory experience of haptics in the real world. the haptics media may include one or more haptics signals. The haptics signal is configured for representing haptics experience, and can render a presented signal. The haptics signal may include, but is not limited to, a vibrotactile signal, a pressure haptics signal, a speed haptics signal, a temperature haptics signal, and the like. According to different haptics signals, haptics types of the haptics media are also different. For example, the haptics signal is the vibrotactile signal, and a haptics type of the haptics media is vibrotactile media. For another example, the haptics signal is an electrotactile signal, and a haptics type of the haptics media is electrotactile media.

In the embodiments of this application, the haptics media may be classified into time-sequence haptics media and non-time-sequence haptics media according to whether there is a time sequence between included haptics signals. There is a time sequence between the haptics signals in the time-sequence haptics media. There is no time sequence between the haptics signals in the non-time-sequence haptics media.

In addition, in the embodiments of this application, the haptics media may be classified into reusable haptics media and another haptics media according to whether the included haptics signal is repeatedly used. the reusable haptics media is haptics media in which the included haptics signal can be repeatedly used (that is, a quantity of times of use is greater than a quantity of times threshold). Correspondingly, the haptics signal included in the reusable haptics media may be referred to as a knowledge haptics signal. the reusable haptics media may include one or more knowledge haptics signals. the another haptics media is haptics media in which an included haptics signal is not repeatedly used (that is, a quantity of times of use is less than or equal to a quantity of times threshold) during presentation. Correspondingly, the haptics signal included in the another haptics media may be referred to as an ordinary haptics signal, and the another haptics media may include one or more ordinary haptics signals. For example, the haptics media includes the vibrotactile media and the electrotactile media. the vibrotactile media is repeatedly used during presentation, and then the vibrotactile media is the reusable haptics media. However, the electrotactile media is not repeatedly used during presentation, and the electrotactile signal is the another haptics media. the reusable haptics media may include time-sequence reusable haptics media and/or non-time-sequence reusable haptics media. Similarly, the another haptics media may include ordinary time-sequence haptics media and/or ordinary non-time-sequence haptics media.

In the embodiments of this application, a relationship between the reusable haptics media and the another haptics media may include the following several cases: \textcircled{1} There is no association relationship between the reusable haptics media and the another haptics media. That is, the another haptics media can be independently presented without depending on the reusable haptics media. There is an association relationship between the reusable haptics media and the another haptics media. The association relationship includes a dependency relationship. The dependency relationship means that the another haptics media needs to depend on the reusable haptics media during presentation.

### 4. Track

The track refers to a media data set in a media file encapsulation process, and one track includes a plurality of samples having a time sequence. One media file may include one or more tracks. For example, one video media file may include, but is not limited to, a video media track, an audio media track, and a subtitle media track. Particularly, metadata information may also be used as a media type, and is included in the media file in a form of a metadata track. The metadata information is a collective name for information related to presentation of haptics media. The metadata information may include at least one of the following: description information of media content of the haptics media, dependency information on which the haptics media depends, property information of the haptics media, signaling information related to presentation of the media content of the haptics media, or the like. In the embodiments of this application, time-sequence haptics media is included in a media file of the haptics media in a form of haptics media track.

### 5. Sample

The sample is an encapsulation unit in a media file encapsulation process. One track includes a plurality of samples. For example, one video media track may include a plurality of samples, and one sample is usually one video frame. In the embodiments of this application, as described above, the time-sequence haptics media may be included in the media file of the haptics media in the form of the haptics media track. the haptics media track includes one or more samples, and each sample may include one or more haptics signals in the time-sequence haptics media.

### 6. Sample Entry

The sample entry is configured for indicating metadata information related to all samples in a track. For example, a sample entry of a video media track usually includes metadata information related to initialization of a consumption device. For another example, a sample entry of haptics media track usually includes metadata information related to reusable haptics media on which a sample depends.

### 7. Sample Group (or Sample Group)

The sample group is a group obtained by performing group division on a sample in a track according to a specific rule. The specific rule herein may be set according to an actual requirement. For example, the specific rule may be performing group division according to whether the sample includes a knowledge haptics signal. Alternatively, the specific rule may be performing group division according to a resolution of the sample, and the like. This is not limited in the embodiments of this application. The embodiments of this application relate to a knowledge haptics sample group. The knowledge haptics sample group is obtained by performing group division on a sample in haptics media track according to whether the sample in the track includes the knowledge haptics signal. That is, all samples including the knowledge haptics signals in the haptics media track may be grouped into one knowledge haptics sample group. In this case, the knowledge haptics sample group may be configured for identifying a sample including the knowledge haptics signal in the haptics media track.

In addition, the embodiments of this application further relate to a reference knowledge haptics sample group. That is, all samples that depend on a knowledge haptics signal in the haptics media track are grouped into one reference knowledge haptics sample group. In this case, the reference knowledge haptics sample group may be configured for identifying a sample that depends on a knowledge haptics signal in the haptics media track.

### 7. Item

The item is an encapsulation unit of non-time-sequence media data in a media file encapsulation process. For example, one static picture may be encapsulated as one item. In the embodiments of this application, non-time-sequence reusable haptics media may be encapsulated as one or more items, and another non-time-sequence haptics media may also be encapsulated as one or more items.

### 8. Moving Picture Experts Group (MPEG)

The MPEG is an organization that is established by the international standardization organization (ISO) and the international electrotechnical commission (IEC) and that specially develops international standards for moving images and voice compression. Haptics perception (MPEG_haptics.perception) is defined in the MPEG. In the definition, the MPEG_haptics.perception element explicitly specifies an identifier of the haptics perception, description information and metadata information of the haptics perception, a reference to an avatar, a reference device list, a channel list, and the like. For descriptions of the haptics perception, refer to Table 1.

TABLE 1
Description of haptics perception

| | | Default | | Whether |
|---|---|---|---|---|
| Property | Type | value | Description | required |
| Identifier (id) | Integer | N/A | Unique identifier for | Yes |
| | | | haptics perception, and a | |
| | | | value of the identifier | |
| | | | needs to be greater than 0 | |
| | | | or equal to 0 | |
| Perception_modality | Enum<string> | N/A | Indicate a type of | Yes |
| | | | perception, and a value | |
| | | | of the perception | |
| | | | modality field may be: | |
| | | | “Pressure” | |
| | | | “Acceleration” | |
| | | | “Velocity” | |
| | | | “Position” | |
| | | | “Temperature” | |
| | | | “Vibrotactile” | |
| | | | “Water” | |
| | | | “Wind” | |
| | | | “Force” | |
| | | | “Electrotactile” | |
| | | | “Vibrotactile | |
| | | | texture” | |
| | | | “Stiffness” | |
| | | | “Friction” | |
| | | | “Other” | |
| Description | String | N/A | Consumer-defined | Yes |
| | | | haptics perception | |
| | | | description | |
| Avatar_id | Integer | N/A | Indicate a unique | Yes |
| | | | identifier of an | |
| | | | associated avatar body | |
| | | | model (Unique identifier | |
| | | | of the associated avatar | |
| | | | body model from 7.2.2) | |
| Effect_library | Array<MPEG_haptics.effect> | N/A | Predefined | Yes |
| (knowledge effect) | | | MPEG_haptics.effect list | |
| | | | defined in 7.2.8. The list | |
| | | | may be empty. The | |
| | | | knowledge effect is | |
| | | | directly referred in a | |
| | | | channel | |
| Reference_devices | Array<MPEG_haptics.reference_devices> | N/A | Device list or actuator | No |
| | | | list of a target MPEG | |
| | | | haptics reference device | |
| | | | for the haptics perception | |
| | | | defined in 7.2.4 | |
| Channels | Array<MPEG_haptics.channel> | N/A | MPEG haptics channel | Yes |
| | | | list that forms the haptics | |
| | | | perception and that is | |
| | | | defined in 7.2.5 | |
| Unit_exponent | Integer | −3 | Indicate identification of | No |
| | | | an exponent of the power | |
| | | | of 10 of an SI unit of an | |
| | | | independent variable | |
| | | | representation space (for | |
| | | | each input perception | |
| | | | unit, refer to 6.4) | |
| Perception_unit_exponent | Integer | 0 | SI unit metric of a | No |
| | | | dependent variable (for | |
| | | | each output perception | |
| | | | unit, refer to 6.4) | |

Further, a haptics effect (namely, MPEG_haptics.effect) is defined in the MPEG. Each MPEG_haptics.band (haptics band) is formed by a haptics effect defined by the MPEG_haptics.effect element. The haptics effect has properties such as an effect type, a position, a phase, a signal type, an optional combination, and a keyframe list. The properties of the haptics effect may be shown in Table 2.

TABLE 2
A property list of an MPEG_haptics.band object corresponding to a property defined in the MPEG

| | | Default | | Whether |
|---|---|---|---|---|
| Property | Type | value | Description | required |
| Identifier | Integer | N/A | Identifier of a haptics | No |
| (id) | | | effect. The property is | |
| | | | required for a knowledge | |
| | | | haptics effect and a haptics | |
| | | | effect of a type | |
| | | | “Reference”. For the | |
| | | | haptics effect of the type | |
| | | | “Reference”, the field | |
| | | | corresponds to a | |
| | | | knowledge haptics effect | |
| | | | that is depended. A value | |
| | | | of the field needs to be | |
| | | | greater than or equal to 0 | |
| Effect_type | Enum<string> | Basis | Indicate a type of the | Yes |
| | | | haptics effect. A value of | |
| | | | the field is one of the | |
| | | | following: “Basis”, | |
| | | | “Composite”, and | |
| | | | “Reference” | |
| | | | Basis: an effect including | |
| | | | signal data (included in a | |
| | | | series of keyframes) | |
| | | | Composite: an effect | |
| | | | formed by a series of other | |
| | | | effects (indicated by a | |
| | | | combination-related | |
| | | | property) that are | |
| | | | combined. This type of | |
| | | | haptics effect does not | |
| | | | directly include the | |
| | | | keyframes | |
| | | | Reference: Refer to a | |
| | | | haptics effect of a | |
| | | | knowledge haptics effect. | |
| | | | The effect is associatively | |
| | | | referenced to a specific | |
| | | | knowledge haptics effect | |
| | | | through the identifier of the | |
| | | | knowledge haptics effect | |
| Position | Integer | 0 | Indicate time domain or a | Yes |
| | | | spatial position of the | |
| | | | haptics effect A value of | |
| | | | the field needs to be greater | |
| | | | than or equal to 0 | |
| Phase | Number | 0 | Phase of the haptics effect. | Yes |
| | | | A value range of the field | |
| | | | is [0, 6.28318] | |
| Base_signal | Enum<string> | Sine | Indicate a type of a | No |
| (basic signal | | | waveform signal. The field | |
| type) | | | is a required field for a | |
| | | | vectorial wave band. A | |
| | | | possible value of the field | |
| | | | is: | |
| | | | “Sine” | |
| | | | “Square” | |
| | | | “Triangle” | |
| | | | “SawToothUp” | |
| | | | “SawToothDown” | |
| Composition | Array<MPEG_haptics.effect> | N/A | The property exists only in | No |
| (composition signal) | | | a haptics effect whose type | |
| | | | is composition. The | |
| | | | property includes a series | |
| | | | of haptics effects. The | |
| | | | haptics effect whose type is | |
| | | | composition does not | |
| | | | directly include keyframes | |
| Keyframes | Array<MPEG_haptics.keyframe> | N/A | A series of keyframes. The | No |
| (keyframe | | | property is a required field | |
| array) | | | for an effect of a | |
| | | | benchmark type. If an array | |
| | | | corresponding to the | |
| | | | property is empty, a | |
| | | | corresponding effect does | |
| | | | not include haptics signal | |
| | | | data. | |

### 9. ISO Based Media File Format (ISOBMFF)

The ISOBMFF is a packaging standard for a media file. The most typical ISOBMFF file is an MP4 file.

### 10. Dynamic Adaptive Streaming Over HTTP (DASH).

The DASH is an adaptive bit rate technology that enables high-quality streaming media to be delivered over the internet through a conventional HTTP web server.

11. Media Presentation Description (MPD, Media Presentation Description Signaling in DASH).

The MPD is configured for describing media segment information in a media file.

### 12. Smart Media Transport (SMT)

The SMT is a novel media distribution technology standard oriented toward a plurality of types of network transmission, and allows different operating frequency bands and transmission capabilities of a broadcast network and a cellular network to be used. SMT signaling may include a group descriptor. The group descriptor is configured for describing a media resource and indicating a relationship between the media resource and another media resource. Definition of the group descriptor is shown in Table 3.

TABLE 3

| Syntax | Value | Bit quantity | Remarks |
|---|---|---|---|
| Asset_group_descriptor( ) { | | | |
| descriptor_tag | | 16 | uimsbf |
| descriptor_length | | 16 | uimsbf |
| reserved | ‘111’ | 3 | |
| dependency_flag | | 1 | blsbf |
| composition_flag | | 1 | blsbf |
| equivalence_flag | | 1 | blsbf |
| similarity_flag | | 1 | blsbf |
| combine_qr_flag | | 1 | blsbf |
| if(dependency_flag) { | | | |
| num_dependencies | N1 | 8 | uimsbf |
| for(i=0; i<N1; i++) { | | | |
| asset_id( ) | | | |
| } | | | |
| } | | | |
| if(composition_flag) { | | | |
| num_compositions | N2 | 8 | uimsbf |
| for(i=0; i<N2; i++) { | | | |
| asset_id( ) | | | |
| } | | | |
| } | | | |
| if(equivalence_flag) { | | | |
| equivalence_selection_level | | 8 | uimsbf |
| num_equivalences | N3 | 8 | uimsbf |
| for(i=0; i<N3; i++) { | | | |
| asset_id( ) | | | |
| equivalence_selection_level | | 8 | uimsbf |
| } | | | |
| } | | | |
| if(similarity_flag) { | | | |
| similarity_selection_level | | 8 | uimsbf |
| num_similarities | N4 | 8 | uimsbf |
| for(i=0; i<N4; i++) { | | | |
| asset_id( ) | | | |
| similarity_selection_level | | 8 | uimsbf |
| } | | | |
| } | | | |
| if(combine_quality_flag) { | | | |
| combine_quality_ranking | | 8 | uimsbf |
| num_combine_assets | N5 | 8 | uimsbf |
| for(i=0; i<N5; i++) { | | | |
| asset_id( ) | | | |
| } | | | |
| } | | | |
| } | | | |

Meanings of the fields in the group descriptor are as follows.

Descriptor tag field (descriptor_tag): A length of the field is 16 bits, and the field is configured for indicating a tag value of a descriptor of this type. The length herein refers to the bit quantity. Unless otherwise specified, related descriptions in the following embodiments refer to the bit quantity.

Descriptor length field (descriptor_length): A length of the field is 16 bits, and the field is configured for indicating a byte length of the descriptor, which is calculated from a next field to a last field.

Dependency flag field (dependency_flag): A length of the field is 1 bit, and the field is configured for indicating whether a dependency relationship needs to be added to the descriptor. When a value of the field is a first preset value (for example, ‘1’), it indicates that the dependency relationship needs to be added to the descriptor. When a value of the field is a second preset value (for example, ‘0’), it indicates that no dependency relationship needs to be added to the descriptor.

Composition flag field (composition_flag): A length of the field is 1 bit, and the field is configured for indicating whether a composition relationship needs to be added to the descriptor. When a value of the field is a first preset value (for example, ‘1’), it indicates that the composition relationship needs to be added to the descriptor. When a value of the field is a second preset value (for example, ‘0’), it indicates that no composition relationship needs to be added to the descriptor.

Combined quality level field (combine_qr_flag): A length of the field is 1 bit, and the field is configured for indicating whether a plurality of assets as a whole that have a composition relationship have a combined quality level. When a value of the field is a first preset value (for example, ‘1’), it indicates that the plurality of assets as a whole that have the composition relationship have a combined quality level. When a value of the field is a second preset value (for example, ‘0’), it indicates that the plurality of assets that have the composition relationship do not have the combined quality level.

Equivalence flag field (equivalence_flag): A length of the field is 1 bit, and the field is configured for indicating whether an equivalence relationship needs to be added to the descriptor. When a value of the field is a first preset value (for example, ‘1’), it indicates that the equivalence relationship needs to be added to the descriptor. When a value of the field is a second preset value (for example, ‘0’), it indicates that no equivalence relationship needs to be added to the descriptor.

Similarity flag field (similarity_flag): A length of the field is 1 bit, and the field is configured for indicating whether a similarity relationship needs to be added to the descriptor. When a value of the field is a first preset value (for example, ‘1’), it indicates that the similarity relationship needs to be added to the descriptor. When a value of the field is a second preset value (such as ‘0’), it indicates that no similarity relationship needs to be added to the descriptor.

Dependency quantity field (num_dependencies): A length of this field is 8 bits, and the field is configured for indicating a quantity of assets on which the asset described by the descriptor depends.

Composition quantity field (num_compositions): A length of the field is 8 bits, and the field is configured for indicating a quantity of assets that have a composition relationship with the asset described by the descriptor.

Equivalence selection level field (equivalence_selection_level): A length of the field is 8 bits, and the field indicates a presentation level of a corresponding asset in an equivalence relationship group. A value of the equivalence selection level field is a second preset value (for example, ‘0’), indicating that the asset is presented by default. When the asset cannot be selected by default, an asset having a lower presentation level is selected and presented as an alternative.

Equivalence quantity field (num_equivalence): A length of the field is 8 bits, and the field is configured for indicating a quantity of assets having an equivalence relationship with the asset described by the descriptor.

Similarity selection level field (similarity_selection_level): A length of the field is 8 bits, and the field is configured for indicating a presentation level of a corresponding asset in a similarity relationship group. A value of the similarity selection level field is a second preset value (for example, ‘0’), indicating that the asset is presented by default. When the asset cannot be selected by default, an asset having a lower presentation level is selected and presented as an alternative.

Similarity quantity field (num_similarities): A length of the field is 8 bits; and the field is configured for indicating a quantity of assets that have a similarity relationship with the asset described by the descriptor.

Combined quality level field (combine_quality_ranking): The field is configured for indicating a combined quality level of a plurality of assets as a whole. An asset having a lower combined quality level as a whole has better presentation quality.

Combined quantity group field (num_combine_assets): The field is configured for indicating a quantity of assets that have a combined quality level relationship with the asset described by the descriptor.

Group descriptor field (asset_id): The field indicates an identifier of an asset in an asset group descriptor, namely, asset_id in the asset group descriptor:

When the asset group descriptor is configured for indicating a dependency relationship, the asset_id field indicates an identifier of an asset on which the asset described by the descriptor depends, and in addition, an asset identifier sequence provided in the descriptor corresponds to an internal coding dependency layer thereof;
when the asset group descriptor is configured for indicating a composition relationship, the asset_id field indicates an identifier of an asset that has the composition relationship with the asset described by the descriptor;
when the asset group descriptor is configured for indicating an equivalence relationship, the asset_id field indicates an identifier of an asset that has the equivalence relationship with the asset described by the descriptor;
when the asset group descriptor is configured for indicating a similarity relationship, the asset_id field indicates an identifier of an asset that has the similarity relationship with the asset described by the descriptor; and
when the asset group descriptor is configured for indicating a combined quality relationship, the asset_id field indicates an identifier of an asset that has the combined quality relationship with the asset described by the descriptor.

### 13. Representation

The representation refers to a combination of one or more media components in DASH. The media component refers to an element or a component that forms media, for example, text, an image, an audio, or a video. For example, a video file with a specific resolution may be considered as one representation. For example, a video file at a time domain level may be considered as one representation.

### 14. Adaptation Set:

The adaptation set refers to a set of one or more video streams in DASH, and one adaptation set may include a plurality of representations. A video stream refers to consecutive video data transmitted through a network.

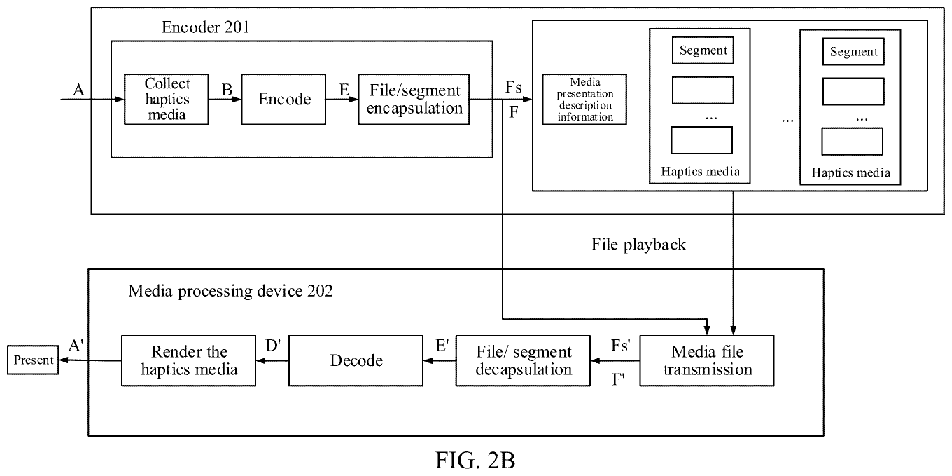

The following provides an introduction for a data processing system suitable for implementing the haptics media provided in the embodiments of this application with reference to FIG. 2A. As shown in FIG. 2A, a data processing system 20 for haptics media may include a service device 201 and a consumption device 202. The service device 201 may be used as an encoder side of the haptics media, and encodes and encapsulates the haptics media, to form a media file of the haptics media. The consumption device 202 may be used as a decoder side of the haptics media, to decode and consume a media file of the haptics media, so as to present reusable haptics media. In an implementation, the service device 201 may be a terminal device or a server; or the consumption device 202 may be a terminal device or a server. The terminal device may be a smartphone, a tablet computer, a notebook computer, a desktop computer, a smart speaker, a smart watch, a vehicle-mounted terminal, a smart television, a smart wearable device, a smart interactive device, or the like, but is not limited thereto. The server may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. A communication connection may be established between the service device 201 and the consumption device 202.

In an embodiment, a specific procedure in which the service device 201 and the consumption device 202 perform data processing on the haptics media is as follows: The service device 201 mainly includes the following data processing processes: (1) a process of obtaining the haptics media; and (2) a process of performing encoding and file encapsulation on the haptics media. For the consumption device 202, the following data processing processes are mainly included: (3) a process of performing file decapsulation and decoding on the haptics media; and (4) a process of presenting the haptics media. In addition, a transmission process involving the haptics media between the service device 201 and the consumption device 202 may be performed based on various transmission protocols (or transmission signaling). The transmission protocols may include but are not limited to: a DASH protocol, an HTTP live streaming (HLS) protocol, a smart media transport protocol (SMTP), a transmission control protocol (TCP), and the like. The data processing process for the haptics media is described in detail below.

### (1) A Process of Obtaining the Haptics Media.

The service device 201 may obtain the haptics media, and the haptics media may include one or more haptics signals. Different haptics signals may correspond to different manners of obtaining the haptics media. For example, for a vibrotactile signal, a manner of obtaining corresponding vibrotactile media may be collecting, through a capture device (such as a sensor) associated with the service device 201, a vibrotactile signal having a specific frequency and strength. The specific frequency herein may be set according to an actual condition. For example, the specific frequency may be set to range from 20 Hz to 1000 Hz based on a frequency range of vibrotaction that can be sensed by human beings. The strength herein may be measured through amplitude or magnitude of the vibration. For another example, for an electrotactile signal, a manner of obtaining corresponding electrotactile media may be collecting an electric impulse through the capture device associated with the service device 201, to form the electrotactile signal. The capture device may be determined according to a type of a collected haptics signal, and may include, but is not limited to, a camera device, a sensing device, and a scanning device. The camera device may include an ordinary camera, a stereoscopic camera, a light field camera, and the like. The sensing device may include a laser device, a radar device, and the like. The scanning device may include a three-dimensional laser scanning device, and the like.

### (2) A Process of Performing Encoding and File Encapsulation on the Haptics Media.

The service device 201 may perform encoding processing on haptics media, to obtain a bitstream of the haptics media. In an implementation, a haptics signal in the haptics media exists in an original pulse code modulation (PCM) form. A coding standard for coding processing herein may be, for example, a pulse coding standard, a digital coding standard, or the like, and a formed bitstream of the haptics media may be a binary bitstream. reusable haptics media in the haptics media is determined according to a property of the reusable haptics media. For example, if the reusable haptics media has a property of repeated presentation, haptics media that has the property of repeated presentation in the haptics media may be determined as the reusable haptics media. Presentation indication information of the reusable haptics media is added. The presentation indication information may be configured for indicating transmission and presentation of the reusable haptics media.

In an embodiment, the presentation indication information of the reusable haptics media may include metadata information of the reusable haptics media, and the service device 201 may generate the metadata information of the reusable haptics media according to a property of the reusable haptics media. Further, the haptics media may include the reusable haptics media and another haptics media. In this case, the presentation indication information of the reusable haptics media may include relationship indication information. That the presentation indication information of the reusable haptics media is added includes: determining an association relationship between the reusable haptics media and the another haptics media, and generating the relationship indication information based on the association relationship. The relationship indication information is configured for indicating the association relationship between the reusable haptics media and the another haptics media.

The service device 201 may perform encapsulation processing on the bitstream of the haptics media and the presentation indication information of the reusable haptics media, to obtain a media file of the haptics media. The encapsulation processing herein may include the following several manners:
(1) the reusable haptics media in the haptics media includes non-time-sequence reusable haptics media. In this case, the non-time-sequence reusable haptics media and the presentation indication information of the reusable haptics media in the bitstream may be encapsulated as a static reusable haptics media item, and the another haptics media in the bitstream is encapsulated as an item or a track, to form the media file of the haptics media.
(2) the haptics media includes time-sequence haptics media, and the time-sequence haptics media includes time-sequence reusable haptics media. In this case, the time-sequence haptics media and the presentation indication information of the reusable haptics media may be encapsulated as haptics media track. In an implementation, the time-sequence haptics media further includes the another haptics media. The service device 201 may encapsulate the another haptics media as the haptics media track, and the haptics media track includes one or more samples; and encapsulate the time-sequence reusable haptics media into a sample entry. In this case, the presentation indication information of the reusable haptics media includes the sample entry.
(3) the haptics media includes the time-sequence haptics media, the time-sequence haptics media includes the time-sequence reusable haptics media and the another haptics media, and the another haptics media includes ordinary time-sequence haptics media. In this case, the time-sequence reusable haptics media and the presentation indication information of the reusable haptics media may be encapsulated as one or more reusable haptics media tracks, and the ordinary time-sequence haptics media is encapsulated as one or more ordinary haptics media tracks, to form the media file of the haptics media.

After obtaining the media file of the haptics media, the service device 201 may transmit the media file of the haptics media to the consumption device 202, so that the consumption device 202 may perform decoding and consumption on a bitstream in the media file according to the presentation indication information of the reusable haptics media.

In an embodiment, the media file of the haptics media may be transmitted in a streaming transmission manner. The streaming transmission manner refers to dividing the media file of the haptics media into a plurality of file segments for transmission. In this case, a file segment of the media file of the haptics media is transmitted between the service device 201 and the consumption device 202 based on transmission signaling. In this case, description information of the presentation indication information of the reusable haptics media may be included in the transmission signaling, and content of the presentation indication information is described through the description information, to provide guidance for the consumption device 202 to perform, as required, decoding and consumption on one or more file segments that are in the media file of the haptics media and that include the reusable haptics media.

### (3) A Process of Performing Decapsulation and Decoding on Files of the Haptics Media.

The consumption device 202 may obtain the media file of the haptics media and corresponding media presentation description information. The media presentation description information is configured for describing related information of the media file of the haptics media. For example, the media presentation description information includes the description information of the presentation indication information, and is configured for describing the presentation indication information of the reusable haptics media in the media file of the haptics media. A file decapsulation process of the consumption device 202 is opposite to a file encapsulation process of the service device 201. The consumption device 202 decapsulates the media file according to a file format requirement of the haptics media, to obtain the bitstream of the haptics media. A decoding process of the consumption device 202 is opposite to an encoding process of the service device 201. The consumption device 202 decodes the bitstream of the haptics media, to restore the reusable haptics media. In the decoding process, the consumption device 202 may obtain the presentation indication information of the reusable haptics media from the media file, and perform decoding processing on the reusable haptics media included in the bitstream of the haptics media according to the presentation indication information of the reusable haptics media. Further, the presentation indication information includes relationship indication information. The relationship indication information is configured for indicating the association relationship between the reusable haptics media and the another haptics media. The consumption device 202 may perform, according to the association relationship indicated by the relationship indication information, decoding processing on the another haptics media and the reusable haptics media on which the another haptics media depends.

In an embodiment, the media file of the haptics media may be transmitted in a streaming transmission manner. In this case, the consumption device 202 may obtain the description information of the presentation indication information of the reusable haptics media included in the transmission signaling (such as DASH and SMT), and obtain, from the media file according to the association relationship indicated by the presentation indication information, the file segments that need to be decoded and consumed and that include the reusable haptics media and the file segments including the another haptics media to perform decoding processing.

### (4) A Process of Presenting the Haptics Media.

The consumption device 202 may perform rendering processing on the reusable haptics media obtained through decoding, to obtain a knowledge haptics signal in the reusable haptics media, and present the knowledge haptics signal in the reusable haptics media. Optionally, the consumption device 202 may perform rendering processing on the another haptics media obtained through decoding, to obtain a haptics signal of the another haptics media, and present the knowledge haptics signal in the reusable haptics media and an ordinary haptics signal in the another haptics media according to the association relationship indicated by the relationship indication information.

In an embodiment, FIG. 2B is a flowchart of data processing of haptics media. The procedure includes:

a data processing procedure of haptics media performed by the service device 201: collecting haptics media B, where the haptics media includes a knowledge haptics signal A of the reusable haptics media; performing encoding processing on the collected haptics media B, to obtain a bitstream E of the haptics media; and determining the reusable haptics media in the haptics media, adding the presentation indication information of the reusable haptics media, and performing encapsulation processing on the bitstream E and the presentation indication information of the reusable haptics media to obtain the media file of the haptics media. In an implementation, the service device 201 synthesizes, according to a specific media container file format, one or more bitstreams into a media file F configured for file playback. In another implementation, the service device 201 processes, according to the specific media container file format, the one or more bitstreams into an initialization segment and a media file segment (FS) that are configured for streaming transmission. The media container file format may be an ISO basic media file format specified in an international organization for standardization (ISO)/international electrotechnical commission (IEC) 14496-12.

A data processing procedure of haptics media performed by the consumption device 202 includes: receiving the media file sent by the service device 201, where the media file may include: a media file F′ configured for file playback, or an initialization segment and a file segment Fs′ of the media file that are configured for streaming transmission; performing decapsulation processing on the media file, to obtain a bitstream E′; obtaining the presentation indication information of the reusable haptics media from the media file, or obtaining the presentation indication information of the reusable haptics media from the description information of the presentation indication information included in the transmission signaling, and decoding the bitstream E′ based on the presentation indication information of the reusable haptics media, to obtain the reusable haptics media D′; and performing rendering on the decoded reusable haptics media D′, to obtain the knowledge haptics signal A′ of the reusable haptics media, and presenting the reusable haptics media on a screen of a head-mounted display or any other display device corresponding to the consumption device 202 according to the presentation indication information.

The data processing of the haptics media may be applied to a product related to haptics feedback, and links such as a service node (an encoder side), a play node (a decoder side), and an intermediate node (a relay side) of an immersive system. A data processing technology for haptics media in this application may be implemented depending on a cloud technology. For example, a cloud server is used as the encoder side. The cloud technology is a hosting technology that unifies a series of resources such as hardware, software, and networks in a wide area network or a local area network to implement computing, storage, processing, and sharing of data.

In the embodiments of this application, a decoder side (a consumption device) of the haptics media may obtain the media file of the haptics media, the haptics media includes the reusable haptics media, and the media file includes the bitstream of the haptics media and the presentation indication information of the reusable haptics media; and perform decoding processing on the bitstream according to the presentation indication information of the knowledge haptics signal to present the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

In this embodiment of this application, several descriptive fields may be added at a system layer, including a field expansion at a file encapsulation layer and a field expansion at a signaling message layer, to support implementation operations of this application. Next, the data processing method for the haptics media provided in the embodiments of this application is described by using an example in which an existing ISOBMFF data box, DASH signaling, and SMT signaling are expanded.

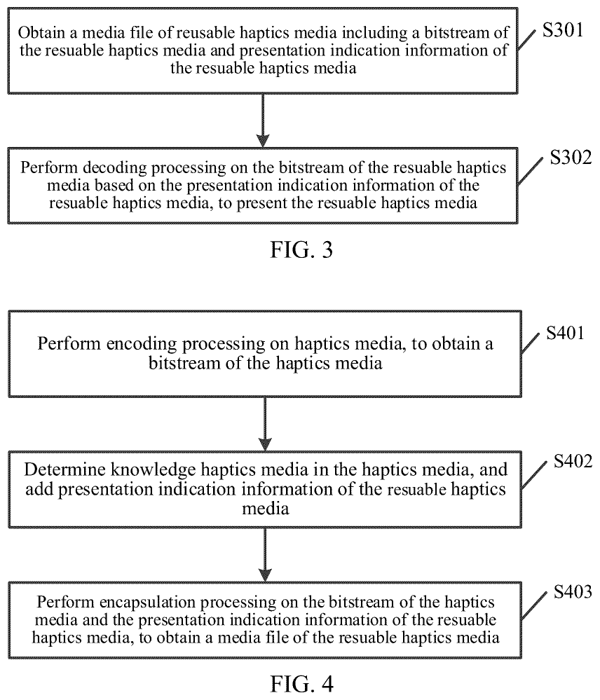

FIG. 3 shows a data processing method for haptics media according to an embodiment of this application. The data processing method for the haptics media may be performed by a consumption device (namely, a decoder side), and the data processing method for the haptics media may include the following operation 301 and operation 302.

Operation 301: Obtain a media file of reusable haptics media including a bitstream of the reusable haptics media and presentation indication information of the reusable haptics media.

A bitstream may be a binary bitstream or a bitstream with another numeral system (such as a quaternary bitstream or a hexadecimal bitstream). the haptics media may include reusable haptics media and/or another haptics media. the reusable haptics media may include non-time-sequence reusable haptics media and/or time-sequence reusable haptics media; and the reusable haptics media may include one or more knowledge haptics signals. the another haptics media may include ordinary non-time-sequence haptics media and/or ordinary time-sequence haptics media, and the another haptics media may include one or more ordinary haptics signals.

The haptics signal involved in this embodiment of this application may be a haptics signal defined by any standard. For example, one haptics signal may be one haptics effect defined in an MPEG (MPEG_haptics.effect).

In this embodiment of this application, a corresponding label and group may be added to the knowledge haptics signal in the reusable haptics media, to facilitate the consumption device to extract the knowledge haptics signal in a targeted manner. In addition, when the knowledge haptics signal in the reusable haptics media is repeatedly used, signal repetition indication information (such as a repetition flag bit field, a repetition interval field, or a repetition count field) may be further added. In an embodiment, the presentation indication information of the reusable haptics media includes metadata information of the reusable haptics media, and the metadata information is configured for indicating a property of the reusable haptics media; and the metadata information includes at least one of the following fields: an identifier field, a type field, a position field, a phase field, a basic signal type field, a composition signal field, a keyframe array field, a label field, a group identifier field, a repetition flag bit field, a repetition interval field, and a repetition count field, where the label field is configured for indicating a label of a knowledge haptics signal included in the reusable haptics media; the group identifier field is configured for indicating a group identifier of a group to which the knowledge haptics signal in the reusable haptics media belongs; the repetition flag bit field is configured for indicating whether the knowledge haptics signal in the reusable haptics media needs to be repeated; the repetition interval field is configured for indicating a time interval between two times of repetition when the knowledge haptics signal in the reusable haptics media needs to be repeated; and the repetition count field is configured for indicating a repetition count of the knowledge haptics signal in the reusable haptics media.

For example, an example in which the knowledge haptics signal is the haptics effect defined in the MPEG is used. Each MPEG_haptics.band element is formed by one or more haptics effects, and the haptics effect is defined by a haptics effect element (MPEG_haptics.effect). The haptics effect element may include a type field, a position field, and a phase field, and may include an identifier field, a basic signal type field, a composition signal field, and a keyframe array field. Further, the haptics effect element may include a label field, a group identifier field, a repetition flag bit field, a repetition interval field, and a repetition count field. In this case, for property descriptions of the MPEG_haptics.effect, refer to Table 4.

TABLE 4
Property description of the haptics effect

| | | Default | | Whether |
|---|---|---|---|---|
| Property | Type | value | Description | required |
| Id (identifier | Integer | N/A | Indicate an identifier of | No |
| field) | | | a haptics effect. A | |
| | | | property indicated by the | |
| | | | field is required for a | |
| | | | knowledge haptics effect | |
| | | | and a haptics effect | |
| | | | whose type is | |
| | | | “Reference”. For the | |
| | | | haptics effect of the type | |
| | | | “Reference”, the field | |
| | | | corresponds to a | |
| | | | knowledge haptics effect | |
| | | | that is depended. A value | |
| | | | of the field needs to be | |
| | | | greater than or equal to 0 | |
| Effect_type | Enum<string> | Basis | Indicate a type of the | Yes |
| (type field) | | | haptics effect. A value of | |
| | | | the field is one of the | |
| | | | following: “Basis”, | |
| | | | “Composite”, and | |
| | | | “Reference” | |
| | | | Basis: an effect | |
| | | | including signal data | |
| | | | (included in a series of | |
| | | | keyframes) | |
| | | | Composite: an effect | |
| | | | formed by a series of | |
| | | | other effects (indicated | |
| | | | by a combination-related | |
| | | | property) that are | |
| | | | combined. This type of | |
| | | | haptics effect does not | |
| | | | directly include the | |
| | | | keyframes | |
| | | | Reference: Refer to a | |
| | | | haptics effect of a | |
| | | | knowledge haptics | |
| | | | effect. The effect is | |
| | | | associatively referenced | |
| | | | to a specific knowledge | |
| | | | haptics effect through | |
| | | | the identifier of the | |
| | | | knowledge haptics effect | |
| Position | Integer | 0 | Indicate time domain or | Yes |
| (position | | | a spatial position of the | |
| field) | | | haptics effect A value of | |
| | | | the field needs to be | |
| | | | greater than or equal to 0 | |
| Phase (phase | Number | 0 | Indicate a phase of the | Yes |
| field) | | | haptics effect. A value | |
| | | | range of the field is [0, | |
| | | | 6.28318] | |
| Base_signal | Enum<string> | Sine | Indicate a type of a | No |
| (basic signal | | | waveform signal. The | |
| type field) | | | field is a required field | |
| | | | for a vectorial wave | |
| | | | band. A possible value | |
| | | | of the field is: | |
| | | | “Sine” | |
| | | | “Square” | |
| | | | “Triangle” | |
| | | | “SawToothUp” | |
| | | | “SawToothDown” | |
| Composition | Array<MPEG_haptics.effect> | N/A | A property indicated by | No |
| (composition | | | the field exists only in a | |
| signal field) | | | haptics effect whose | |
| | | | type is composition. The | |
| | | | property includes a | |
| | | | series of haptics effects. | |
| | | | The haptics effect whose | |
| | | | type is composition does | |
| | | | not directly include | |
| | | | keyframes | |
| Keyframes | Array<MPEG_haptics.keyframe> | N/A | Indicate a series of | No |
| (keyframes | | | keyframes. A property | |
| array field) | | | indicated by the field is | |
| | | | a required field for an | |
| | | | effect of a benchmark | |
| | | | type. If an array | |
| | | | corresponding to the | |
| | | | property is empty, a | |
| | | | corresponding effect | |
| | | | does not include haptics | |
| | | | signal data. | |
| Label (label | String | N/A | Indicate a label of a | No |
| field) | | | haptics effect. The label | |
| | | | may be configured for | |
| | | | rapid positioning and | |
| | | | extraction of the haptics | |
| | | | effect | |
| Group_id | Integer | N/A | Indicate a group | No |
| (group | | | identifier of a group to | |
| identifier | | | which the haptics effect | |
| field) | | | belongs. The group | |
| | | | identifier is configured | |
| | | | for classification of the | |
| | | | haptics effect | |
| Repeat_signal | Bool | False | Indicate whether the | No |
| (repeat flag bit | | | haptics effect needs to | |
| field) | | | be repeated. If the | |
| | | | haptics effect needs to | |
| | | | be repeated, the current | |
| | | | haptics effect is repeated | |
| | | | according to a | |
| | | | corresponding time | |
| | | | interval | |
| Repeat_interval | Integer | N/A | Indicate a time interval | No |
| (repeat interval | | | between two times of | |
| field) | | | repetition of the haptics | |
| | | | effect. When a value of | |
| | | | the repeat_signal is true, | |
| | | | the property is required | |
| Repeat_count | Integer | N/A | Indicate a repetition | No |
| (a repetition | | | count of the haptics | |
| count field) | | | effect. When a value of | |
| | | | the repeat_signal is true, | |
| | | | the property is required | |

Based on a property of the knowledge haptics signal in the reusable haptics media in the foregoing table, correspondingly, when storage is performed in a preset numeral system format, the following expansion is performed on storage of the knowledge haptics signal: storing metadata information of the reusable haptics media (for example, in the MPEG, the metadata information of the reusable haptics media is represented as MPEG_haptics_libraryEffect metadata), and the preset numeral system may be binary, quaternary, or the like. Correspondingly, the foregoing bitstream may be a binary bitstream, a quaternary bitstream, or the like. For example, parsing syntax of the knowledge haptics signal in the reusable haptics media in a binary storage format may be shown in Table 5.

TABLE 5
Parsing syntax of a knowledge haptics
signal in reusable haptics media

| | No. of | |
|---|---|---|
| Syntax | bits | Mnemonic |
| MPEG_haptics_libraryEffect( ) | | |
| { | | |
| id; | 16 | uimsbf |
| position; | 24 | uimsbf |
| phase; | 16 | decimal |
| baseSignal; | 4 | uimsbf |
| effectType; | 2 | uimsbf |
| keyframeCount; | 16 | uimsbf |
| label | 32 | string |
| group_id | 16 | uimsbf |
| repeat_signal | 1 | bool |
| if(repeat_signal==1) { | | |
| repeat_count | 16 | uimsbf |
| repeat_interval | 16 | uimsbf |
| } | | |
| for(i=0; i<keyframeCount; i++) { | | |
| informationMask; | 3 | uimsbf |
| if((informationMask & 0x01)!=0) { | | |
| relativePosition; | 16 | uimsbf |
| } | | |
| if((informationMask & 0x02)!=0) { | | |
| amplitude; | 8 | decimal |
| } | | |
| if((informationMask & 0x04)!=0) { | | |
| frequency; | 16 | uimsbf |
| } | | |
| } | | |
| compositionEffectCount; | 16 | uimsbf |
| for(i=0; i<compositionEffectCount; i++) { | | |
| MPEG_Haptics_libraryEffect( ); | | |
| } | | |
| } | | |

For meanings of some of the fields in Table 5, refer to Table 4, and for meanings of the remaining fields, refer to Table 6.

TABLE 6

| | |
|---|---|
| keyframeCount | Quantity of keyframes included in a current |
| | haptics effect |
| informationMask | Binary mask, configured for distinguishing a |
| | type of a keyframe |
| relativePosition | Relative time domain/spatial position of a |
| | corresponding keyframe |
| amplitude | An amplitude value of a corresponding |
| | keyword, and a value range is [−1; 1] |
| frequency | Frequency of a corresponding keyframe |
| compositionEffectCount | A quantity of sub-effects included in the |
| | composition effect |

Ordinary haptics signals may also be grouped, and a corresponding label and a corresponding group identifier are added to the ordinary haptics signals.

In an embodiment, when the reusable haptics media includes non-time-sequence reusable haptics media, the non-time-sequence reusable haptics media may be stored in a static storage method. When the reusable haptics media includes the time-sequence reusable haptics media, the time-sequence reusable haptics media is stored in a dynamic storage method. The static storage method and the dynamic storage method are different manners of storing data. The static storage method refers to determining a size and a position of storage space in advance, and a storage position of data is fixed as time changes. The dynamic storage method refers to dynamically allocating and releasing the storage space as required, and the storage position of the data may vary with time.

### (1) Store the Non-Time-Sequence Reusable Haptics Media in the Static Storage Method

the non-time-sequence haptics media may be encapsulated as reusable haptics media item of a target type in a media file. For example, the target type may be represented as ‘ahle’. There may be one or more reusable haptics media items, and one reusable haptics media item may include one or more knowledge haptics signals in the non-time-sequence reusable haptics media.

In an embodiment, the presentation indication information includes relationship indication information, and the relationship indication information is configured for indicating an association relationship between the non-time-sequence reusable haptics media and the another haptics media. the another haptics media includes ordinary time-sequence haptics media and/or ordinary non-time-sequence haptics media. In this case, the relationship indication information may include an entity group, the entity group includes one or more entities, and the entities in the entity group may include the reusable haptics media item or the another haptics media. The entity group is configured for indicating that the another haptics media in the entity group depends on haptics media item in the entity group during presentation.

In an implementation, the media file includes N reusable haptics media items, where Nis an integer greater than 1. The relationship indication information may include N entity groups. In this case, each of the N entity groups includes only one reusable haptics media item; and entity groups to which different reusable haptics media items belong are distinguished through identifiers of the entity group. Syntax of the entity group is shown in Table 7

TABLE 7

```
aligned(8) class AVSHapticsLibraryEntityBox extends
EntityToGroupBox(‘ahle’) {
unsigned int(32) group_id;
    unsigned int(32) num_entities_in_group;
    for(i=0; i<num_entities_in_group; i++) {
      unsigned int(32) entity_id;
      unsigned int(1) library_haptics_flag;
      bit(7) reserved;
      if(library_haptics_flag==1) {
        unsigned int(8) num_library_haptics;
for(i=0; i<num_library_haptics; i++) {
        unsigned int(16) library_haptics_id;
        unsigned int(8) library_group_id;
        string library_label;
}
}
  }
}
```

Semantics of the fields in Table 7 are as follows.

Entity group identifier field (group_id): The entity group identifier field is configured for indicating an identifier of the entity group, and different entity groups have different identifiers.

Entity quantity field (num_entities_in_group): The entity quantity field is configured for indicating a quantity of entities in the entity group.

Entity identifier field (entity_id): The entity identifier field is configured for indicating an entity identifier in the entity group, and the entity identifier is the same as an item identifier of an item to which an identified entity belongs, or the entity identifier is the same as a track identifier of a track to which an identified entity belongs; and different entities have different entity identifiers.

Knowledge haptics flag field (library_haptics_flag): The knowledge haptics flag field is configured for indicating whether a current entity includes the knowledge haptics signal; when a value of the knowledge haptics flag field is a first preset value (such as “1”), it indicates that the current entity includes the knowledge haptics signal; and when a value of the knowledge haptics flag field is a second preset value (such as “0”), it indicates that the current entity does not include the knowledge haptics signal.

Knowledge haptics quantity field (num_library_haptics): The knowledge haptics quantity field is configured for indicating a quantity of knowledge haptics signals included in the current entity.

Knowledge haptics identifier field (library_haptics_id): The knowledge haptics identifier field is configured for indicating an identifier of a current knowledge haptics signal in the current entity.

Knowledge haptics group identifier field (library_group_id): The knowledge haptics group identifier field is configured for indicating a group identifier of a group to which the current knowledge haptics signal belongs.

Knowledge haptics label field (library_label): The knowledge haptics label field is configured for indicating a label of the current knowledge haptics signal.

The current entity is an entity that is in the entity group and that is being decoded; and the current knowledge haptics signal is a knowledge haptics signal that is in the current entity and that is being decoded.

As another implementation, all the reusable haptics media items and the another haptics media that depends on the reusable haptics media item may be further organized through one entity group. In this case, the entity group includes one or more reusable haptics media items in the media file, and each reusable haptics media item is a knowledge haptics entity in the entity group. In this case, syntax of the entity group is shown in Table 8.

TABLE 8

```
aligned(8) class AVSHapticsLibraryEntityBox extends
EntityToGroupBox(‘ahle’) {
unsigned int(32) group_id;
    unsigned int(32) num_entities_in_group;
    for(i=0; i<num_entities_in_group; i++) {
      unsigned int(32) entity_id;
      unsigned int(8) num_library_haptics;
        for(j=0; i<num_library_haptics; j++) {
unsigned int(16) library_haptics_id;
unsigned int(8) library_group_id;
          string library_label;
}
unsigned int(8) num_library_reference;
        for(k=0; k<num_library_reference; k++) {
    unsigned int(32) referred_entity_id;
}
  }
}
```

Meanings of the fields in Table 8 are as follows.

Entity group identifier field (group_id): The entity group identifier field is configured for indicating an identifier of the entity group, and different entity groups have different identifiers.

Entity quantity field (num_entities_in_group): The entity quantity field is configured for indicating a quantity of entities in the entity group.

Entity identifier field (entity_id): The entity identifier field is configured for indicating an entity identifier in the entity group, and the entity identifier is the same as an item identifier of reusable haptics media item to which an identified entity belongs; and different entities have different entity identifiers.

Knowledge haptics quantity field (num_library_haptics): The knowledge haptics quantity field is configured for indicating a quantity of knowledge haptics signals included in a current knowledge haptics entity in the entity group.

Knowledge haptics identifier field (library_haptics_id): The knowledge haptics identifier field is configured for indicating an identifier of a current knowledge haptics signal in the current knowledge haptics entity.

Knowledge haptics group identifier field (library_group_id): The knowledge haptics group identifier field is configured for indicating a group identifier of a group to which the current knowledge haptics signal belongs.

Knowledge haptics label field (library_label): The knowledge haptics label field is configured for indicating a label of the current knowledge haptics signal.

Reference knowledge haptics quantity field (num_library_reference): The reference knowledge haptics quantity field is configured for indicating a quantity of other entities that depend on the current knowledge haptics entity.

Referred entity identifier field (referred_entity_id): The referred entity identifier field is configured for indicating an identifier of the another entity that depends on the current knowledge haptics entity.

The current knowledge haptics entity is a knowledge haptics entity that is in the entity group and that is being decoded, and the current knowledge haptics signal is a knowledge haptics signal that is in the current knowledge haptics entity and that is being decoded.

### (2) Store the Time-Sequence Reusable Haptics Media in the Dynamic Storage Method

\textcircled{1} The time-sequence reusable haptics media and the another haptics media are encapsulated into the same haptics media track, and the time-sequence reusable haptics media is encapsulated into a sample entry of the haptics media track.

In an embodiment, the time-sequence haptics media may be encapsulated as haptics media track in the media file, the haptics media track includes one or more samples, and one sample includes one or more haptics signals of the time-sequence haptics media; and the time-sequence reusable haptics media is encapsulated into a sample entry of the haptics media track. In this case, the presentation indication information of the reusable haptics media includes the sample entry, the sample entry is configured for indicating a property of the time-sequence reusable haptics media, and syntax of the sample entry is shown in Table 9.

```
TABLE 9
aligned(8) class AVSHapticsSampleEntryextends HapticSampleEntry
(‘ahap’) {
unsigned int(1) library_haptics_flag;
bit(7) reserved;
if(library_haptics_flag==1) {
unsigned int(8) num_library_haptics;
for(i=0; i<num library_haptics; i++) {
  unsigned int(16) library_haptics_id;
unsigned int(8) library_group_id;
  string library_label;
  unsigned int(16) library_haptics_length;
  bit(8)*library_haptics_length library_haptics;
}
}
}
```

Semantics of the fields in Table 9 are as follows.

Static knowledge haptics flag field (library_haptics_flag): The static knowledge haptics flag field is configured for indicating whether the haptics media track includes a static knowledge haptics signal; when a value of the static knowledge haptics flag field is a first preset value (such as “1”), it indicates that the haptics media track includes the static knowledge haptics signal; and when a value of the static knowledge haptics flag field is a second preset value (such as “0”), it indicates that the haptics media track does not include the static knowledge haptics signal. The static knowledge haptics signal means that a knowledge haptics signal does not vary with time.

Knowledge haptics quantity field (num_library_haptics): The knowledge haptics quantity field is configured for indicating a quantity of knowledge haptics signals included in the time-sequence reusable haptics media.

Knowledge haptics identifier field (library_haptics_id): The knowledge haptics identifier field is configured for indicating an identifier of a current knowledge haptics signal in the time-sequence reusable haptics media.

Knowledge haptics group identifier field (library group_id): The knowledge haptics group identifier field is configured for indicating a group identifier of a group to which the current knowledge haptics signal belongs.

Knowledge haptics label field (library_label): The knowledge haptics label field is configured for indicating a label of the current knowledge haptics signal.

Knowledge haptics length field (library_haptics_length): The knowledge haptics length field is configured for indicating a length of the current knowledge haptics signal.

Knowledge haptics content field (library_graphics): The knowledge haptics content field is configured for indicating content of the current knowledge haptics signal.

The current knowledge haptics signal is a knowledge haptics signal that is in the time-sequence reusable haptics media and that is being decoded.

Further, the time-sequence haptics media further includes another haptics media. the another haptics media includes ordinary time-sequence haptics media. The presentation indication information of the reusable haptics media includes relationship indication information, and the relationship indication information is configured for indicating an association relationship between the time-sequence reusable haptics media and the another haptics media. In this case, a sample that is in the haptics media track and that depends on the reusable haptics media further needs to be identified. For example, the sample may be identified through a reference knowledge haptics sample group. In this case, the haptics media track includes a reference knowledge haptics sample group (AVSHapticsLibRefGroup), the reference knowledge haptics sample group includes one or more samples in the haptics media track, and any sample in the reference knowledge haptics sample group depends on the knowledge haptics signal in the time-sequence reusable haptics media; and the relationship indication information includes an entry of the reference knowledge haptics sample group, and the entry of the reference knowledge haptics sample group is configured for indicating that the another haptics media in the haptics media track depends on, during presentation, the time-sequence reusable haptics media in the haptics media track. Syntax of the relationship indication information is shown in Table 10.

TABLE 10

```
  aligned(8) class AVSHapticsLibRefGroupEntry extends
HapticSampleGroupEntry (‘alrg’) {
  unsigned int(8) num_refer_library_haptics;
  for(i=0; i<num_refer_library_haptics; i++) {
    unsigned int(16) refer_library_haptics_id;
  unsigned int(8) refer_library_group_id;
    string refer_library_label;
  }
  }
```

Semantics of the fields in Table 10 are as follows.

Reference knowledge haptics quantity field (num_refer_library_haptics): The reference knowledge haptics quantity field is configured for indicating a quantity of knowledge haptics signals on which a current sample in the haptics media track depends; and the current sample is a sample that is in the haptics media track and that is being decoded.

Reference knowledge haptics identifier field (reference_library_haptics_id): The reference knowledge haptics identifier field is configured for indicating an identifier of a knowledge haptics signal on which a current sample depends.

Reference knowledge haptics group identifier field (refer_library_group_id): The reference knowledge haptics group identifier field is configured for indicating a group identifier of a group to which a knowledge haptics signal on which a current sample depends belongs.

Reference knowledge haptics label field (refer_library_label): The reference knowledge haptics label field is configured for indicating a label of the knowledge haptics signal on which the current sample depends.

\textcircled{2} The time-sequence reusable haptics media and the another haptics media are encapsulated into the same haptics media track, and the time-sequence reusable haptics media is stored in a sample of the haptics media track.

In an embodiment, the time-sequence haptics media may be encapsulated as haptics media track in the media file, the haptics media track includes one or more samples, and one sample includes one or more haptics signals of the time-sequence haptics media. In this case, a sample including a knowledge haptics signal needs to be identified in the haptics media track. For example, the sample including the knowledge haptics signal is identified through the knowledge haptics sample group. In this case, the haptics media track includes the knowledge haptics sample group (AVSHapticsLibraryGroup), the knowledge haptics sample group includes one or more samples, and any sample in the knowledge haptics sample group includes one or more knowledge haptics signals in the time-sequence reusable haptics media. The presentation indication information of the reusable haptics media includes an entry of the knowledge haptics sample group. Syntax of the entry of the knowledge haptics sample group is shown in Table 11.

TABLE 11

```
  aligned(8) class AVSHapticsLibraryGroupEntry extends
HapticSampleGroupEntry (‘albg’) {
  unsigned int(8) num library_haptics;
  for(i=0; i<num_library_haptics; i++) {
    unsigned int(16) library_haptics_id;
  unsigned int(8) library_group_id;
  string library label;
  }
  }
```

Semantics of the fields in Table 11 are as follows.

Knowledge haptics quantity field (num_library_graphics): The knowledge haptics quantity field is configured for indicating a quantity of knowledge haptics signals included in a current sample in the knowledge haptics sample group; and the current sample is a sample that is in the knowledge haptics sample group and that is being decoded.

Knowledge haptics identifier field (library_haptics_id): The knowledge haptics identifier field is configured for indicating an identifier of a current knowledge haptics signal in the current sample; and the current knowledge haptics signal is a knowledge haptics signal that is in the current sample and that is being decoded.

Knowledge haptics group identifier field (library_label): The knowledge haptics group identifier field is configured for indicating a group identifier of a group to which the current knowledge haptics signal belongs.

Knowledge haptics label field (library_label): The knowledge haptics label field is configured for indicating a label of the current knowledge haptics signal.

Further, the haptics media may further include another haptics media. the another haptics media includes ordinary time-sequence haptics media. The presentation indication information of the reusable haptics media includes relationship indication information, and the relationship indication information is configured for indicating an association relationship between the time-sequence reusable haptics media and the another haptics media. In this case, the haptics media track may include a reference knowledge haptics sample group, the reference knowledge haptics sample group includes one or more samples in the haptics media track, and any sample in the reference knowledge haptics sample group depends on the knowledge haptics signal in the time-sequence reusable haptics media; and the relationship indication information includes an entry of the reference knowledge haptics sample group, and the entry of the reference knowledge haptics sample group is configured for indicating that the another haptics media in the haptics media track depends on, during presentation, the time-sequence reusable haptics media in the haptics media track.

An advantage of storing the knowledge haptics signal in a sample of the haptics media track is: When there are many knowledge haptics signals, the knowledge haptics signals may be distributed in the sample of the haptics media track according to the association relationship between the ordinary haptics media and the reusable haptics media. In this case, it needs to be ensured that a decoding time point of a sample to which the time-sequence reusable haptics media in the haptics media track belongs is equal to or earlier than a decoding time point of a sample to which the another haptics media that depends on the time-sequence reusable haptics media belongs.

\textcircled{3} The time-sequence reusable haptics media in the haptics media and the another haptics media are respectively encapsulated in different tracks.

the haptics media includes time-sequence reusable haptics media and another haptics media that depends on the time-sequence reusable haptics media, and the another haptics media includes ordinary time-sequence haptics media. In this case, the time-sequence reusable haptics media is encapsulated as one or more reusable haptics media tracks in the media file, any reusable haptics media track includes one or more samples, and any sample in any reusable haptics media track includes one or more knowledge haptics signals in the time-sequence reusable haptics media; and any reusable haptics media track includes a knowledge haptics sample group, and the knowledge haptics sample group is configured for identifying metadata information of the time-sequence reusable haptics media.

The ordinary time-sequence haptics media is encapsulated as one or more ordinary haptics media tracks in the media file; any ordinary haptics media track includes one or more samples, and any sample in the any ordinary haptics media track includes one or more haptics signals in the ordinary time-sequence haptics media; and the any ordinary media track includes a reference knowledge haptics sample group, and the reference knowledge haptics sample group is configured for identifying metadata information of the ordinary haptics media that depends on the reusable haptics media. The presentation indication information of the reusable haptics media includes relationship indication information, and the relationship indication information is configured for indicating an association relationship between the time-sequence reusable haptics media and the another haptics media.

In this case, the relationship indication information includes a track reference of a preset type. The ordinary haptics media track is associated with reusable haptics media track on which the ordinary haptics media track depends through the track reference of the preset type. The sample in the ordinary haptics media track is aligned with the sample in the reusable haptics media track on which the ordinary haptics media track depends, that is, aligned samples have the same decoding time point and the same presentation time point. In this case, it needs to be ensured that the decoding time point of the sample to which the time-sequence reusable haptics media in the haptics media track belongs is equal to or earlier than the decoding time point of the sample to which the another haptics media that depends on the time-sequence reusable haptics media belongs. The preset type may be represented as ‘ahlr’. For example, an ordinary haptics media track 1 depends on reusable haptics media track 1. In this case, the haptics media track 1 is associated with the reusable haptics media track 1 through track reference (track_IDs) of ‘ahlr’. Syntax of the relationship indication information is shown in Table 12.

TABLE 12

```
  aligned(8) class AVSLibraryHapticsSampleEntry extends
HapticSampleEntry (‘albh’) {
  }
  aligned(8) class TrackReferenceTypeBox (‘ahlr’) extends
  Box(‘ahlr’) {
  unsigned int(32) track_IDs[ ];
  }
```

In an embodiment, the haptics media may be transmitted in a streaming transmission manner, and the obtaining a media file of haptics media may include: obtaining transmission signaling of the haptics media, the transmission signaling including description information of the presentation indication information of the reusable haptics media; and obtaining the media file of the haptics media according to the transmission signaling. The transmission signaling may be DASH signaling, SMT signaling, or the like. At a transmission signaling layer, reusable haptics media resource including the knowledge haptics signal and an ordinary haptics media resource that depends on the reusable haptics media resource need to be identified.

### (1) The Transmission Signaling is the DASH Signaling

The description information may include haptics media information descriptor in the DASH signaling. One element with a property value of @schemeIdUri being “urn: aves:haptics:hapticsInfo” represents one haptics media information descriptor, and the haptics media information descriptor is configured for defining metadata information of a corresponding haptics media resource, the haptics media information descriptor is configured for identifying the reusable haptics media resource including the knowledge haptics signal and the ordinary haptics media resource that depends on the reusable haptics media resource. the haptics media information descriptor is configured for describing media resources at at least one of the following levels: haptics media resource at a representation level and haptics media resource at an adaption set level.

There may be one or more haptics media information descriptors in MPD signaling of the DHSH signaling. Syntax and semantics of the haptics media information descriptor are shown in Table 13.

TABLE 13

| Element and property of haptics media | | | |
|---|---|---|---|
| information descriptor | Usage | Data type | Description |
| AVSHapticsInfo (haptics information | 0 . . . N | avs:haptics:hapticsInfo | The element is |
| element) | | | configured for |
| | | | indicating metadata |
| | | | information of a |
| | | | current haptics |
| | | | media resource |
| AVSHapticsInfo@non_timed_media_flag | Required | xs:bool | The element is |
| (media resource type element) | | | configured for |
| | | | indicating a type of |
| | | | a current haptics |
| | | | media resource. |
| | | | When a value of |
| | | | the media resource |
| | | | type element is the |
| | | | first preset value |
| | | | (such as “1”), it |
| | | | indicates that the |
| | | | current haptics |
| | | | media resource is a |
| | | | static non-time- |
| | | | sequence media |
| | | | resource. When a |
| | | | value of the media |
| | | | resource type |
| | | | element is the |
| | | | second preset value |
| | | | (such as “0”), it |
| | | | indicates that the |
| | | | current haptics |
| | | | media resource is a |
| | | | dynamic time- |
| | | | sequence media |
| | | | resource |
| AVSHapticsInfo@library_haptics_info | Required | xs:unsignedInt | The element is |
| (knowledge haptics information element) | | | configured for |
| | | | indicating a signal |
| | | | type in a current |
| | | | haptics media |
| | | | resource. When a |
| | | | value of the |
| | | | knowledge haptics |
| | | | information |
| | | | element is the first |
| | | | preset value (such |
| | | | as “1”), it indicates |
| | | | that the current |
| | | | haptics media |
| | | | resource includes |
| | | | only a knowledge |
| | | | haptics signal. |
| | | | When a value of |
| | | | the knowledge |
| | | | haptics information |
| | | | element is the |
| | | | second preset value |
| | | | (such as “0”), it |
| | | | indicates that the |
| | | | current haptics |
| | | | media resource |
| | | | includes only an |
| | | | ordinary haptics |
| | | | signal, and does |
| | | | not depend on |
| | | | another media |
| | | | resource including |
| | | | the knowledge |
| | | | haptics signal. |
| | | | When a value of |
| | | | the knowledge |
| | | | haptics information |
| | | | element is a third |
| | | | preset value (such |
| | | | as “2”), it indicates |
| | | | that the current |
| | | | haptics media |
| | | | resource includes |
| | | | an ordinary haptics |
| | | | signal, and depends |
| | | | on another media |
| | | | resource including |
| | | | the knowledge |
| | | | haptics signal |
| AVSHapticsInfo@library_id (knowledge | Optional | xs:UIntVectorType | The element is |
| haptics identifier element) | | | configured for |
| | | | indicating an |
| | | | identifier of the |
| | | | knowledge haptics |
| | | | signal included in |
| | | | the current haptics |
| | | | media resource |
| AVSHapticsInfo@library_group_id | Optional | xs:UIntVectorType | The element is |
| (knowledge haptics group identifier | | | configured for |
| element) | | | indicating a group |
| | | | identifier of a |
| | | | group to which the |
| | | | knowledge haptics |
| | | | signal included in |
| | | | the current haptics |
| | | | media resource |
| | | | belongs |
| AVSHapticsInfo@library_label | Optional | xs:Vector<string> | The element is |
| (knowledge haptics label element) | | | configured for |
| | | | indicating a label |
| | | | of the knowledge |
| | | | haptics signal |
| | | | included in the |
| | | | current haptics |
| | | | media resource |
| AVSHapticsInfo@refer_library_id | Optional | xs:UIntVectorType | The element is |
| (reference knowledge haptics identifier | | | configured for |
| element) | | | indicating an |
| | | | identifier of the |
| | | | knowledge haptics |
| | | | signal on which the |
| | | | current haptics |
| | | | media resource |
| | | | depends |
| AVSHapticsInfo@refer_library_group_id | Optional | xs:UIntVectorType | The element is |
| (reference knowledge haptics group | | | configured for |
| identifier element) | | | indicating a group |
| | | | identifier of a |
| | | | group to which the |
| | | | knowledge haptics |
| | | | signal on which the |
| | | | current haptics |
| | | | media resource |
| | | | depends belongs |
| AVSHapticsInfo@refer_library_label | Optional | xs:Vector<string> | The element is |
| (reference knowledge haptics label | | | configured for |
| element) | | | indicating a label |
| | | | of the knowledge |
| | | | haptics signal on |
| | | | which the current |
| | | | haptics media |
| | | | resource depends |

The current haptics media resource is haptics media that is in the bitstream and that is being decoded, and the current haptics media resource includes any one or more of the following: haptics media track, haptics media item, or some samples in the haptics media track.

In another embodiment, the haptics media information descriptor includes a knowledge haptics flag element (@library_haptics_flag), and the knowledge haptics flag element is configured for indicating whether a current media resource includes the knowledge haptics signal. When a value of the knowledge haptics flag element is the first preset value (such as “1”), it indicates that the current media resource includes the knowledge haptics signal. When a value of the knowledge haptics flag element is the second preset value (such as “0”), it indicates that the current media resource includes the ordinary haptics signal. In this case, if the current media resource depends on another haptics media resource including the knowledge haptics signal, the another haptics media resource including the knowledge haptics signal on which the current media resource depends is indicated through a dependency identifier field (@dependencyId) or an association identifier field (@associationId). In this case, semantics of @dependencyId and @associationId in the DASH signaling are shown in Table 14.

TABLE 14

| | | |
|---|---|---|
| @dependencyId | O | Indicate an id of one or more representations on |
| | | which a current representation depends when |
| | | the current representation is decoded or |
| | | presented |
| @associationId | O | Indicate an id of one or more representations |
| | | associated with a current representation when |
| | | the current representation is decoded or |
| | | presented |
| @associationType | O | Indicate a type of an association relationship |
| | | between a current representation and another |
| | | representation |

### (2) The Transmission Signaling is the SMT Signaling

In the embodiments of this application, the media resource including the knowledge haptics signal and a media resource referring to the knowledge haptics signal may be organized by extending a group descriptor of the SMT signaling. In this case, the description information includes an asset group descriptor in the SMT signaling. By using a dependency relationship in the asset group descriptor, the asset group descriptor is configured for describing an ordinary haptics media resource, and indicating reusable haptics media resource on which the ordinary haptics media resource depends and that includes the knowledge haptics signal. In addition, the description information further includes a media resource descriptor, and the media resource descriptor is configured for further indicating metadata information of a corresponding haptics media resource. Syntax of the media resource descriptor is shown in Table 15.

TABLE 15

| Syntax | Value | Bit quantity | Remarks |
|---|---|---|---|
| Haptics_info_descriptor( ) { | | | |
| descriptor_tag | | 16 | uimsbf |
| descriptor_length | | 16 | uimsbf |
| reserved | ‘1111111’ | 7 | |
| haptics_library_flag | | 1 | blsbf |
| if(haptics_library_flag) { | | | |
| num_library_haptics | N1 | 8 | uimsbf |
| for(i=0; i<N1; i++) { | | | |
| library_haptics_id | | 16 | uimsbf |
| library_group_id | | 8 | uimsbf |
| library_label | | | string |
| } | | | |
| else{ | | | |
| num_refer_library_haptics | N2 | 8 | uimsbf |
| for(i=0; i<N2; i++) { | | | |
| refer_library_haptics_id | | 16 | uimsbf |
| refer_library_group_id | | 8 | uimsbf |
| refer_library_label | | | string |
| } | | | |
| } | | | |
| } | | | |

Meanings of the fields in the media resource descriptor are as follows.

Descriptor tag field (descriptor_tag): A length of the field is 16 bits, and the field is configured for indicating a tag value of a descriptor of this type.

Descriptor length field (descriptor_length): A length of the field is 16 bits, and the field is configured for indicating a byte length of the descriptor, which is calculated from a next field to a last field.

Knowledge haptics flag field (haptics_library_flag): The knowledge haptics flag field is configured for indicating whether an asset group described by the asset group descriptor is a media resource including a knowledge haptics signal; when a value of the knowledge haptics flag field is a first preset value (such as “1”), the knowledge haptics flag field is configured for indicating that the asset group described by the asset group descriptor includes only the media resource including the knowledge haptics signal; and in this case, the media resource descriptor includes a knowledge haptics quantity field (num_library_haptics), a knowledge haptics identifier field (library_haptics_id), a knowledge haptics group identifier field (library_group_id), and a knowledge haptics label field (library_label). The knowledge haptics quantity field is configured for indicating a quantity of knowledge haptics signals included in the current media resource. The knowledge haptics identifier field is configured for indicating an identifier of the knowledge haptics signal included in the current media resource, and the knowledge haptics group identifier field is configured for indicating a group identifier of a group to which the knowledge haptics signal included in the current media resource belongs. The knowledge haptics label field is configured for indicating a label of the knowledge haptics signal included in the current media resource.

When a value of the knowledge haptics flag field is a second preset value (such as “0”), the knowledge haptics flag field is configured for indicating that the asset group described by the asset group descriptor includes an ordinary haptics signal, and depends on a media resource including the knowledge haptics signal; and in this case, the media resource descriptor includes a reference knowledge haptics quantity field (num_refer_library_haptics), a reference knowledge haptics identifier field (refer_library_haptics_id), a reference knowledge haptics group identifier field (refer_library group_id), and a reference knowledge haptics label field (refer_library_label). The reference knowledge haptics quantity field is configured for indicating a quantity of knowledge haptics signals on which the current media resource depends. The reference knowledge haptics identifier field is configured for indicating an identifier of the knowledge haptics signal on which the current media resource depends. The reference knowledge haptics group identifier field is configured for indicating a label of the knowledge haptics signal on which the current media resource depends.

The current media resource is haptics media resource that is in the bitstream and that is being decoded, and the current haptics media resource includes any one or more of the following: haptics media track, haptics media item, or some samples in the haptics media track.

Operation 302: Perform decoding processing on the bitstream of the reusable haptics media based on the presentation indication information of the reusable haptics media, to present the reusable haptics media.

In an embodiment, the presentation indication information of the reusable haptics media includes metadata information of the reusable haptics media. The performing decoding processing on the bitstream of the haptics media based on the presentation indication information of the reusable haptics media, to present the reusable haptics media may include: performing decoding processing on the reusable haptics media in the bitstream, obtaining the metadata information of the reusable haptics media from the presentation indication information of the reusable haptics media, and presenting the reusable haptics media based on a property indicated by the metadata information. For example, the obtained metadata information includes an identifier field, a repetition flag bit field, a repetition interval field, and a repetition count field. The identifier field indicates that an identifier of the reusable haptics media is 1, the repetition flag bit field, the repetition interval field, and the repetition count field are respectively configured for indicating that the reusable haptics media needs to be repeated, a time interval between two times of repetition is 10 seconds, and a repetition count is 2. In this case, the reusable haptics media whose identifier is 1 is presented based on the property indicated by the metadata information, and the reusable haptics media is repeatedly presented again after 10 seconds.

In another embodiment, the presentation indication information of the reusable haptics media includes relationship indication information. In this case, the performing decoding processing on the bitstream of the haptics media based on the presentation indication information of the reusable haptics media, to present the reusable haptics media may include: determining, according to an association relationship indicated by the relationship indication information, another haptics media and reusable haptics media on which the another haptics media depends; performing decoding processing on the another haptics media and the reusable haptics media; and presenting the another haptics media and the reusable haptics media according to the association relationship.

In the embodiments of this application, a consumption device may obtain the media file of the haptics media, the haptics media includes the reusable haptics media, and the media file includes the bitstream of the haptics media and the presentation indication information of the reusable haptics media; and perform decoding processing on the bitstream according to the presentation indication information of the knowledge haptics signal to present the haptics media. An encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

FIG. 4 is a schematic flowchart of a data processing method for haptics media according to an embodiment of this application. The data processing method for the haptics media may be performed by a service device (namely, an encoder side), and the data processing method for the haptics media may include the following operation 401 to operation 403.

Operation 401: Perform encoding processing on haptics media, to obtain a bitstream of the reusable haptics media.

Operation 402: Determine reusable haptics media in the haptics media, and add presentation indication information of the reusable haptics media.

In an embodiment, the service device may determine whether a repeatedly used haptics media exists in the haptics media. Repeatedly using herein means that a quantity of times of use is greater than a quantity of times threshold. The quantity of times threshold may be set according to an actual condition. For example, the quantity of times threshold may be 10, 15, or 50. If the repeatedly used haptics media exists in the haptics media, the repeatedly used haptics media is determined as the reusable haptics media, where the reusable haptics media includes one or more knowledge haptics signals.

Operation 403: Perform encapsulation processing on the bitstream of the haptics media and the presentation indication information of the reusable haptics media, to obtain a media file of the haptics media.

the reusable haptics media may include non-time-sequence reusable haptics media and/or time-sequence reusable haptics media. In the embodiments of this application, when the reusable haptics media includes the non-time-sequence reusable haptics media, the non-time-sequence reusable haptics media is stored in a static storage method. When the reusable haptics media includes the time-sequence reusable haptics media, the time-sequence reusable haptics media is stored in a dynamic storage method.

(1) When the reusable haptics media includes the non-time-sequence reusable haptics media, the non-time-sequence reusable haptics media is stored in the static storage method.

In an embodiment, the non-time-sequence reusable haptics media may be encapsulated as reusable haptics media item. When the presentation indication information of the reusable haptics media includes relationship indication information, the performing encapsulation processing on the bitstream of the haptics media and the presentation indication information of the reusable haptics media, to obtain a media file of the haptics media may include: \textcircled{1} encapsulating the non-time-sequence reusable haptics media in the bitstream as the reusable haptics media item, where the reusable haptics media item includes one or more knowledge haptics signals of the non-time-sequence reusable haptics media; and \textcircled{2} generating an entity group of a target type based on an association relationship between the reusable haptics media and another haptics media, to form the media file of the haptics media. In this case, the relationship indication information includes the entity group.

A current knowledge haptics entity is a knowledge haptics entity that is in the entity group and that is being encoded, and the current knowledge haptics signal is a knowledge haptics signal that is in the current knowledge haptics entity and that is being encoded.

(2) When the reusable haptics media includes the time-sequence reusable haptics media, the time-sequence reusable haptics media is stored in the dynamic storage method.

\textcircled{1} The time-sequence reusable haptics media and the another haptics media are encapsulated into the same haptics media track, and the time-sequence reusable haptics media is encapsulated into a sample entry of the haptics media track.

In an embodiment, the haptics media includes time-sequence haptics media, the time-sequence haptics media includes the time-sequence reusable haptics media, and the performing encapsulation processing on the bitstream of the haptics media and the presentation indication information of the reusable haptics media, to obtain a media file of the haptics media may include the following operations: \textcircled{1} encapsulating the time-sequence haptics media as the haptics media track, where the haptics media track includes one or more samples, and one sample includes one or more haptics signals of the time-sequence haptics media; and \textcircled{2} encapsulating the time-sequence reusable haptics media and the presentation indication information of the reusable haptics media into the sample entry of the haptics media track, to form the media file of the haptics media. In this case, the presentation indication information of the reusable haptics media includes the sample entry, and the sample entry is configured for indicating a property of the time-sequence reusable haptics media.

In addition, the time-sequence haptics media further includes the another haptics media. the another haptics media includes ordinary time-sequence haptics media. A sample of a reference reusable haptics media in the haptics media track needs to be identified. For example, identification is performed through a reference knowledge haptics sample group. In this case, the presentation indication information includes the relationship indication information, and the relationship indication information is configured for indicating the association relationship between the reusable haptics media and the another haptics media. The encapsulating the time-sequence reusable haptics media and the presentation indication information of the reusable haptics media into a sample entry of the haptics media track, to form the media file of the haptics media may include: dividing the reference knowledge haptics sample group in the haptics media track according to the association relationship between the reusable haptics media and the another haptics media, and encapsulating the time-sequence reusable haptics media into the sample entry of the haptics media track, to form the media file of the haptics media.

\textcircled{2} The time-sequence reusable haptics media and the another haptics media are encapsulated into the same haptics media track, and the time-sequence reusable haptics media is stored in a sample of the haptics media track.

In an embodiment, the haptics media includes time-sequence haptics media, the time-sequence haptics media includes the time-sequence reusable haptics media, and the performing encapsulation processing on the bitstream of the haptics media and the presentation indication information of the reusable haptics media, to obtain a media file of the haptics media may include: (1) encapsulating the time-sequence haptics media as the haptics media track, where the haptics media track includes one or more samples, and one sample includes one or more haptics signals of the time-sequence haptics media; (2) dividing a knowledge haptics sample group and the reference knowledge haptics sample group in the haptics media track, where the knowledge haptics sample group includes one or more samples, and any sample in the knowledge haptics sample group includes one or more knowledge haptics signals in the time-sequence reusable haptics media; and the reference knowledge haptics sample group includes one or more samples, and any sample in the reference knowledge haptics sample group depends on the knowledge haptics signals in the time-sequence reusable haptics media; and (3) encapsulating the presentation indication information of the reusable haptics media into an entry of the knowledge haptics sample group, to form the media file of the haptics media. An encoding time point of a sample to which the time-sequence reusable haptics media in the haptics media track belongs is equal to or earlier than an encoding time point of a sample to which another haptics media that depends on the time-sequence reusable haptics media belongs.

\textcircled{3} The time-sequence reusable haptics media and the another haptics media are respectively encapsulated into different tracks.

In an embodiment, the haptics media includes the time-sequence haptics media, the time-sequence haptics media includes the time-sequence reusable haptics media, and the another haptics media includes the ordinary time-sequence haptics media. The presentation indication information of the reusable haptics media includes the relationship indication information, and the relationship indication information includes a track reference of a preset type. Operation 403 may include: encapsulating the time-sequence reusable haptics media into one or more reusable haptics media tracks, and encapsulating the ordinary time-sequence haptics media into one or more ordinary haptics media tracks; and then dividing a knowledge haptics sample group in each reusable haptics media track, and dividing a reference knowledge haptics sample group in each ordinary haptics media track, and associating the ordinary haptics media track with the reusable haptics media track on which the ordinary haptics media track depends through the track reference of the preset type, to form the media file of the haptics media.

In an embodiment, the haptics media is transmitted in a streaming transmission manner, description information of the presentation indication information of the reusable haptics media may be generated, and the media file of the haptics media is sent to a consumption device through transmission signaling. The transmission signaling may be DASH signaling, SMT signaling, or the like. For example, if the transmission signaling is the DASH signaling, the description information includes haptics media information descriptor in dynamic adaptive streaming signaling. If the transmission signaling is the SMT signaling, the description information includes an asset group descriptor in intelligent media transmission signaling.

In the embodiments of this application, encoding processing is performed on the haptics media, to obtain a bitstream of the haptics media. Then, reusable haptics media in the haptics media is determined, and presentation indication information of the reusable haptics media is added. Encapsulation processing is performed on the bitstream of the haptics media and the presentation indication information of the reusable haptics media, to obtain a media file of the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side to accurately present the reusable haptics media, thereby improving a presentation effect of the reusable haptics media.

The data processing method for the haptics media provided in this application is described in detail below through specific examples.

Example 1: reusable haptics media includes non-time-sequence reusable haptics media, and is stored in a static storage method. On the premise, the data processing method for the haptics media provided in this application includes the following operations.

1. A service device may obtain the haptics media, and perform encoding processing on the haptics media, to obtain a bitstream of the haptics media; then determine reusable haptics media in the haptics media, for example, identify haptics media that is repeatedly used for a plurality of times in the haptics media as the reusable haptics media; and then add presentation indication information of the reusable haptics media according to a property of the reusable haptics media. The presentation indication information of the reusable haptics media may include metadata information of the reusable haptics media, and the metadata information is configured for indicating the property of the reusable haptics media. the reusable haptics media includes three knowledge haptics signals, namely, LibraryEffect1, LibraryEffect2, and LibraryEffect3. The metadata information of the reusable haptics media is as follows:
LibraryEffect1: @id=1; @group_id=1; @label=‘gunType1’
LibraryEffect2: @id=2; @group_id=1; @label=‘gunType1’
LibraryEffect3: @id=3; @group_id=2; @label=‘gunType2’

For the LibraryEffect1, @id=1 indicates that an identifier of the LibraryEffect1 is 1, @group_id=1 indicates that a group identifier of a group to which the LibraryEffect1 belongs is 1, and @label=‘gunType1’ indicates that a label of the LibraryEffect1 is ‘gunType1’. For the LibraryEffect2, @id=2 indicates that an identifier of the LibraryEffect2 is 2, @group_id=1 indicates that a group identifier of a group to which the LibraryEffect2 belongs is 1, and @label=‘gunType1’ indicates that a label of the LibraryEffect2 is ‘gunType1’. For the LibraryEffect3, @id=3 indicates that an identifier of the LibraryEffect3 is 3, @group_id=2 indicates that a group identifier of a group to which the LibraryEffect3 belongs is 2, and @label-‘gunType2’ indicates that a label of the LibraryEffect3 is ‘gunType2’.

The service device performs encapsulation processing on the bitstream of the haptics media and the presentation indication information of the reusable haptics media, to obtain a media file of the haptics media. Specifically, the haptics media includes the non-time-sequence reusable haptics media and another haptics media. the another haptics media includes ordinary time-sequence haptics media. the non-time-sequence reusable haptics media is encapsulated into two static reusable haptics media items (namely, an item 2 and an item 3), and the ordinary time-sequence haptics media is encapsulated as an ordinary haptics media track (namely, a track 1). Then, the reference knowledge haptics sample group is divided in the ordinary haptics media track, and then the ordinary haptics media track is associated with the static reusable haptics media item, to form the media file of the haptics media. That is, all entities that include the reusable haptics media and another haptics media that depends on the reusable haptics media are associated through one entity group, to finally form the media file of the haptics media. In this case, the presentation indication information of the reusable haptics media includes relationship indication information, and the relationship indication information includes the entity group. The media file is as follows:
track 1: an ordinary haptics media track;
item 2: The item 2 includes the LibraryEffect1 and the LibraryEffect2; and the reusable haptics media item 2 includes two knowledge haptics signals in the non-time-sequence reusable haptics media, namely, the LibraryEffect1 and the LibraryEffect2; and
item 3: The item 3 includes the LibraryEffect3. the reusable haptics media item includes one knowledge haptics signal in the non-time-sequence reusable haptics media, namely, the LibraryEffect3.

### AVSHapticsLibraryEntityBox:

```
{group_id=100; num_entities_in_group=2
  entity id=2; num
library haptics=2:
(library_haptics_id=1; library_group_id=1; library_label=‘gunType1’);
(library_haptics_id=2; library_group_id=1; library_label=‘gunType1’)
num_library_reference=1; referred_entity_id=1}
  {entity_id=3; num_library_haptics=1:
(library_haptics_id=3; library_group_id=2; library_label=‘gunType1’);
num_library_reference=1; referred_entity_id=1}
}
```

AVSHapticsLibraryEntityBox is the entity group, and group_id=100 indicates that an identifier of the entity group is 100. num_entities_in_group=2 indicates that a quantity of entities in the entity group is 2, entity_id=2 indicates that an entity identifier in the entity group is 2, that is, the entity identifier is the same as an item identifier of the item 2 to which the identified entity belongs. num_library_haptics=2 indicates that a quantity of knowledge haptics signals included in the item 2 is 2, namely, the LibraryEffect1 and the LibraryEffect2. library_haptics_id=1 indicates that an identifier of the LibraryEffect1 is 1, library_group_id=1 indicates that a group identifier of a group to which the LibraryEffect1 belongs is 1, and library_label=‘gunType1’ indicates that a label of the LibraryEffect1 is ‘gunType1’. library_haptics_id=2 indicates that an identifier of the LibraryEffect2 is 2, library_group_id=1 indicates that a group identifier of a group to which the LibraryEffect2 belongs is 1, and library_label=‘gunType1’ indicates that a label of the LibraryEffect1 is ‘gunType1’. num_library_reference=1 indicates that a quantity of other entities that depend on the item 2 is 1; and referred_entity_id=1 indicates that an identifier of the another entity that depends on the item 2 is 1 (namely, track 1).

entity_id=3 indicates that an entity identifier in the entity group is 3, that is, the entity identifier is the same as an item identifier of the item 3 to which the identified entity belongs. num_library_haptics=1 indicates that a quantity of knowledge haptics signals included in the item 3 is 1, namely, the LibraryEffect3. library_haptics_id=3 indicates that an identifier of the LibraryEffect3 is 3, library_group_id=2 indicates that a group identifier of a group to which the LibraryEffect3 belongs is 2, and library_label=‘gunType2’ indicates that a label of the LibraryEffect3 is ‘gunType2’. num_library_reference=1 indicates that a quantity of other entities that depend on the item 3 is 1; and referred_entity_id=1 indicates that an identifier of the another entity that depends on the item 3 is 1 (namely, track 1).

In addition, for the track 1, a sample of the reference reusable haptics media in the track 1 is identified through the reference knowledge haptics sample group.

AVSHapticsLibRefGroupEntry1: It is assumed that the AVSHapticsLibRefGroupEntry1 corresponds to a sample 10 to a sample 20.

{
num_refer_library_haptics=1;
refer_library_haptics_id=1; refer_library_group_id=1;
refer_library_label=‘gunType1’
}

AVSHapticsLibRefGroupEntry1 includes the sample 10 to the sample 20. num_refer_library_haptics=1 indicates that a quantity of knowledge haptics signals on which the sample 10 to the sample 20 in the ordinary haptics media track (namely, the track 1) depend is 1, refer_library_haptics_id=1 indicates that an identifier of the knowledge haptics signal on which the sample 10 to the sample 20 depend is 1, and refer_library_group_id=1 indicates that a group identifier of a group to which the knowledge haptics signal on which the sample 10 to the sample 20 depend is 1. refer_library_label=‘gunType1’ indicates that a label of a knowledge haptics signal on which the sample 10 to the sample 20 depend is gunType1.

AVSHapticsLibRefGroupEntry2: It is assumed that the AVSHapticsLibRefGroupEntry2 corresponds to a sample 15 to the sample 20.

{
num_refer_library_haptics=1;
refer_library_haptics_id=2; refer_library_group_id=1;
refer_library_label=‘gunType1’
}

AVSHapticsLibRefGroupEntry2 includes the sample 15 to the sample 20. num_refer_library_haptics=1 indicates that a quantity of knowledge haptics signals on which the sample 15 to the sample 20 in the ordinary haptics media track (namely, the track 1) depend is 1, refer_library_haptics_id=2 indicates that an identifier of the knowledge haptics signal on which the sample 15 to the sample 20 depend is 2, and refer_library_group_id=1 indicates that a group identifier of a group to which the knowledge haptics signal on which the sample 15 to the sample 20 depend is 1. refer_library_label=‘gunType1’ indicates that a label of a knowledge haptics signal on which the sample 15 to the sample 20 depend is gunType1.

AVSHapticsLibRefGroupEntry3: It is assumed that AVSHapticsLibRefGroupEntry3 corresponds to a sample 40 to a sample 50.

{
num_refer_library_haptics=1;
refer_library_haptics_id=3; refer_library_group_id=2;
refer_library_label=‘gunType2’
}

AVSHapticsLibRefGroupEntry3 includes the sample 40 to the sample 50. num_refer_library_haptics=1 indicates that a quantity of knowledge haptics signals on which the sample 40 to the sample 50 in the ordinary haptics media track (namely, the track 1) depend is 1, refer_library_haptics_id=3 indicates that an identifier of the knowledge haptics signal on which the sample 40 to the sample 50 depend is 3, and refer_library_group_id=2 indicates that a group identifier of a group to which the knowledge haptics signal on which the sample 40 to the sample 50 depend is 2. refer_library_label=‘gunType2’ indicates that a label of a knowledge haptics signal on which the sample 40 to the sample 50 depend is gunType2.

3. The service device transmits the media file F of the haptics media to a consumption device. The transmitting the media file F of the haptics media to a consumption device includes the following two types:
(1) The service device may directly transmit the complete media file F to the consumption device; and
(2) the service device may transmit one or more file segments Fs to the consumption device in a streaming manner. During streaming transmission, the service device needs to transmit description information of the presentation indication information of the reusable haptics media to the consumption device through transmission signaling. The consumption device may determine the presentation indication information of the reusable haptics media according to the description information of the presentation indication information, and obtain, according to the transmission signaling, an ordinary reusable haptics media and reusable haptics media on which the ordinary reusable haptics media depends. DASH signaling is used as an example. The description information includes a haptics information descriptor (namely, an AVSHapticsInfo descriptor), and knowledge haptics signals included in different media resources and another media resource depending on the knowledge haptics signal may be indicated through the AVSHapticsInfo descriptor. The AVSHapticsInfo descriptor is as follows:

Representation1: The Representation1 corresponds to the track 1.

{AVSHapticsInfo@non_timed_media_flag=0; @library_haptics_info=2; and @dependencyId=(2, 3)}. AVSHapticsInfo@non_timed_media_flag=0 indicates that the Representation1 is a dynamic time-sequence media resource, library_haptics_info=2 indicates that the Representation1 includes an ordinary haptics signal, and the Representation1 depends on other media resources including knowledge haptics signals. @dependencyId=(2, 3) indicates that identifiers of the other media resources on which the Representation1 depends and that include the knowledge haptics signals are respectively 2 and 3 (that is, the Representation1 depends on Representation2 and Representation3 during presentation).

Representation2: The Representation2 corresponds to the item 2

{AVSHapticsInfo@non_timed_media_flag=1; @library_haptics_info=1; @library_id=(1, 2); @library_group_id=1; @library_label=‘gunType1’}. AVSHapticsInfo@non_timed_media_flag=1 indicates that the Representation2 is a static non-time-sequence media resource. @library_haptics_info=1 indicates that the Representation2 includes only the knowledge haptics signal. @library_id=(1, 2) indicates that identifiers of the two knowledge haptics signals included in the Representation2 are respectively 1 and 2, @library_group_id=1 indicates that group identifiers of groups to which the two knowledge haptics signals included in the Representation2 belong are 1, and @library_label=‘gunType1’ indicates that labels of the two knowledge haptics signals included in the Representation2 are gunType1.

Representation3: Representation3 corresponds to the item 3.

{AVSHapticsInfo@non_timed_media_flag=1; @library_haptics_info=1; @library_id=(3); @library_group_id=2; @library_label=‘gunType2’}. AVSHapticsInfo@non_timed_media_flag=1 indicates that the Representation3 is a static non-time-sequence media resource. @library_haptics_info=1 indicates that the Representation2 includes only the knowledge haptics signal. @library_id=(3) indicates that an identifier of one knowledge haptics signal included in the Representation3 is 3, @library_group_id=2 indicates that a group identifier of a group to which the knowledge haptics signal included in the Representation3 belongs is 2, and @library_label=‘gunType2’ indicates that a label of the knowledge haptics signal included in the Representation2 is gunType2.

4. After obtaining the media file F or the file segment Fs, the consumption device may perform decapsulation processing on the media file F or the file segment Fs according to the presentation indication information of the reusable haptics media, to obtain a bitstream of the haptics media, decode the corresponding reusable haptics media and ordinary haptics media according to the association relationship that is between the reusable haptics media and the ordinary haptics media and that is indicated by the relationship indication information included in the presentation indication information, and present the decoded reusable haptics media and the ordinary haptics media.

(1) For the complete media file F, the consumption device obtains information about an item including the knowledge haptics signal in the media file by parsing the AVSHapticsLibraryEntityBox, and determines the association relationship between the ordinary haptics media and the reusable haptics media through the AVSHapticsLibRefGroupEntry. That is, when presenting the sample 10 to the sample 20 of the track 1, the consumption device may first decode the LibraryEffect1 and the LibraryEffect2 included in the item 2, present the LibraryEffect1 and the LibraryEffect2 after decoding, and then present the ordinary haptics signals included in the sample 10 to the sample 20 of the track 1.

When the sample 40 to the sample 50 of the track 1 are presented, the LibraryEffect3 included in the item 3 is first decoded, the LibraryEffect3 is presented after decoding, and then the ordinary haptics signals included in the sample 40 to the sample 50 of the track 1 are presented.

(2) For streaming transmission, the consumption device may determine, through the description information of the presentation indication information of the reusable haptics media in the transmission signaling, that the Representation1 depends on the Representation2 and the Representation3, and learn that the Representation2 and the Representation3 are static media resources including the knowledge haptics signals.

The consumption device may request a set of file segments Fs corresponding to the Representation1, parse the AVSHapticsLibRefGroupEntry in the file segments Fs, and request the Representation2 in advance when learning that when the file segments corresponding to the sample 10 to the sample 20 are presented. Then, the consumption device may request the Representation2 from the service device, decode the Representation2, to obtain the LibraryEffect1 and the LibraryEffect2, then present the LibraryEffect1 and the LibraryEffect2, and present the ordinary haptics signals included in the sample 10 to the sample 20 after the LibraryEffect1 and the LibraryEffect2 are presented.

When the file segments corresponding to the sample 40 to the sample 50 are presented, the consumption device may request the Representation3 from the service device and decode the Representation3, to obtain the LibraryEffect3; and then, present the LibraryEffect3, and after the LibraryEffect3 is presented, the ordinary haptics signals included in the sample 40 to the sample 50 are presented.

Example 2: The knowledge haptics signal includes time-sequence reusable haptics media, the time-sequence reusable haptics media is stored in a dynamic storage manner, and the time-sequence reusable haptics media is encapsulated into a sample entry of a track. On the premise, the data processing method for the haptics media provided in this application includes the following operations.

1. A service device may obtain the haptics media, and perform encoding processing on the haptics media, to obtain a bitstream of the haptics media; determine reusable haptics media in the haptics media, for example, identify haptics media that is repeatedly used for a plurality of times in the haptics media as the reusable haptics media; and then add presentation indication information of the reusable haptics media according to a property of the reusable haptics media. The presentation indication information of the reusable haptics media may include metadata information of the reusable haptics media. the reusable haptics media includes three knowledge haptics signals, namely, LibraryEffect1, LibraryEffect2, and LibraryEffect3. The metadata information of the reusable haptics media is as follows:
LibraryEffect1: @id=1; @group_id=1; @label=‘gunType1’
LibraryEffect2: @id=2; @group_id=1; @label=‘gunType1’
LibraryEffect3: @id=3; @group_id=2; @label=‘gunType2’

For the LibraryEffect1, @id=1 indicates that an identifier of the LibraryEffect1 is 1, @group_id=1 indicates that a group identifier of a group to which the LibraryEffect1 belongs is 1, and @label=‘gunType1’ indicates that a label of the LibraryEffect1 is ‘gunType1’. For the LibraryEffect2, @id=2 indicates that an identifier of the LibraryEffect2 is 2, @group_id=1 indicates that a group identifier of a group to which the LibraryEffect2 belongs is 1, and @label=‘gunType1’ indicates that a label of the LibraryEffect2 is ‘gunType1’. For the LibraryEffect3, @id=3 indicates that an identifier of the LibraryEffect3 is 3, @group_id=2 indicates that a group identifier of a group to which the LibraryEffect3 belongs is 2, and @label=‘gunType2’ indicates that a label of the LibraryEffect3 is ‘gunType2’.

2. The service device performs encapsulation processing on the bitstream of the haptics media and the presentation indication information of the reusable haptics media, to obtain a media file of the haptics media. Specifically, the haptics media includes time-sequence haptics media. the time-sequence haptics media includes the time-sequence reusable haptics media and another haptics media. the another haptics media includes ordinary time-sequence haptics media. the time-sequence haptics media is encapsulated as haptics media track (namely, the track 1). the haptics media track includes one or more samples. A reference knowledge haptics sample group is divided in the haptics media track, and the time-sequence reusable haptics media is encapsulated into the sample entry of the haptics media track, to form the media file of the haptics media. In this case, the presentation indication information of the reusable haptics media includes the sample entry, and the sample entry is configured for indicating a property of the time-sequence reusable haptics media. The presentation indication information of the reusable haptics media includes relationship indication information, the relationship indication information includes an entry of the reference knowledge haptics sample group, and the entry of the reference knowledge haptics sample group is configured for indicating that the another haptics media in the haptics media track depends on the time-sequence reusable haptics media in the haptics media track during presentation. The media file is as follows:
track 1: haptics media track.

In addition, for the track 1, a sample of the reference reusable haptics media in the track 1 is identified through the reference knowledge haptics sample group.

AVSHapticsLibRefGroupEntry1: It is assumed that the AVSHapticsLibRefGroupEntry1 corresponds to a sample 10 to a sample 20.

{
num_refer_library_haptics=1;
refer_library_haptics_id=1; refer_library_group_id=1;
refer_library_label=‘gunType1’
}

AVSHapticsLibRefGroupEntry1 includes the sample 10 to the sample 20. num_refer_library_haptics=1 indicates that a quantity of knowledge haptics signals on which the sample 10 to the sample 20 in the ordinary haptics media track (namely, the track 1) depend is 1, refer_library_haptics_id=1 indicates that an identifier of the knowledge haptics signal on which the sample 10 to the sample 20 depend is 1, and refer_library_group_id=1 indicates that a group identifier of a group to which the knowledge haptics signal on which the sample 10 to the sample 20 depend is 1. refer_library_label=‘gunType1’ indicates that a label of a knowledge haptics signal on which the sample 10 to the sample 20 depend is gunType1.

AVSHapticsLibRefGroupEntry2: It is assumed that the AVSHapticsLibRefGroupEntry2 corresponds to a sample 15 to the sample 20.

{
num_refer_library_haptics=1;
refer_library_haptics_id=2; refer_library_group_id=1;
refer_library_label=‘gunType1’
}

AVSHapticsLibRefGroupEntry2 includes the sample 15 to the sample 20. num_refer_library_haptics=1 indicates that a quantity of knowledge haptics signals on which the sample 15 to the sample 20 in the ordinary haptics media track (namely, the track 1) depend is 1, refer_library_haptics_id=2 indicates that an identifier of the knowledge haptics signal on which the sample 15 to the sample 20 depend is 2, and refer_library_group_id=1 indicates that a group identifier of a group to which the knowledge haptics signal on which the sample 15 to the sample 20 depend is 1. refer_library_label=‘gunType1’ indicates that a label of a knowledge haptics signal on which the sample 15 to the sample 20 depend is gunType1.

AVSHapticsLibRefGroupEntry3: It is assumed that AVSHapticsLibRefGroupEntry3 corresponds to a sample 40 to a sample 50.

{
num_refer_library_haptics=1;
refer_library_haptics_id=3; refer_library_group_id=2;
refer_library_label=‘gunType2’
}

AVSHapticsLibRefGroupEntry3 includes the sample 40 to the sample 50. num_refer_library_haptics=1 indicates that a quantity of knowledge haptics signals on which the sample 40 to the sample 50 in the ordinary haptics media track (namely, the track 1) depend is 1, refer_library_haptics_id=3 indicates that an identifier of the knowledge haptics signal on which the sample 40 to the sample 50 depend is 3, and refer_library_group_id=2 indicates that a group identifier of a group to which the knowledge haptics signal on which the sample 40 to the sample 50 depend is 2. refer_library_label=‘gunType2’ indicates that a label of a knowledge haptics signal on which the sample 40 to the sample 50 depend is gunType2.

3. The service device transmits the media file F of the haptics media to a consumption device. The transmitting the media file F of the haptics media to a consumption device includes the following two types:

(1) The service device may directly transmit the complete media file F to the consumption device; and

(2) the service device may transmit one or more file segments Fs to the consumption device in a streaming manner. During streaming transmission, the service device needs to transmit description information of the presentation indication information of the reusable haptics media to the consumption device through transmission signaling. The consumption device may determine the presentation indication information of the reusable haptics media according to the description information of the presentation indication information, and obtain, according to the transmission signaling, an ordinary reusable haptics media and reusable haptics media on which the ordinary reusable haptics media depends. DASH signaling is used as an example. The description information includes a haptics information descriptor (namely, an AVSHapticsInfo descriptor), and knowledge haptics signals included in different media resources and another media resource depending on the knowledge haptics signal may be indicated through the AVSHapticsInfo descriptor. Because the reusable haptics media and the ordinary haptics media are located in the same media resource, the AVSHapticsInfo descriptor is as follows:

Representation1: {AVSHapticsInfo@non_timed_media_flag=0; @library_haptics_info=0}. AVSHapticsInfo@non_timed_media_flag=0 indicates that the Representation1 is a dynamic time-sequence media resource, library_haptics_info=0 indicates that the Representation1 includes an ordinary haptics signal, and the Representation1 does not depend on other media resources including knowledge haptics signals.

4. After obtaining the media file F or the file segment Fs, the consumption device may perform decapsulation processing on the media file F or the file segment Fs according to the presentation indication information of the reusable haptics media, to obtain a bitstream of the haptics media, decode the corresponding reusable haptics media and ordinary haptics media according to the association relationship that is between the reusable haptics media and the ordinary haptics media and that is indicated by the relationship indication information included in the presentation indication information, and present the decoded reusable haptics media and the ordinary haptics media.

(1) For the complete media file F, the consumption device determines the association relationship between the ordinary haptics media and the reusable haptics media through the AVSHapticsLibRefGroupEntry. That is, the consumption device may first decode the LibraryEffect1 and the LibraryEffect2 in the track 1 when presenting the sample 10 to the sample 20 of the track 1, present the LibraryEffect1 and the LibraryEffect2 after decoding, and then present the sample 10 to the sample 20 of the track 1.

When the sample 40 to the sample 50 of the track 1 are presented, the LibraryEffect3 included in the track 1 is first decoded, the LibraryEffect3 is presented after decoding, and then the sample 40 to the sample 50 of the track 1 are presented.

(2) For streaming transmission, the consumption device determines, through the description information of the presentation indication information of the reusable haptics media in the transmission signaling, that the Representation1 includes the ordinary haptics signal and does not depend on the other media resources including the knowledge haptics signals.

The consumption device may request a set of file segments Fs corresponding to the Representation1, parse the AVSHapticsLibRefGroupEntry in the file segments Fs, and when learning that when the sample 10 to the sample 20 are presented, first perform decoding processing on the LibraryEffect1 and the LibraryEffect2 in the track 1, and then present the LibraryEffect1 and the LibraryEffect2. After the LibraryEffect1 and the LibraryEffect2 are presented, the ordinary haptics signals included in the sample 10 to the sample 20 are presented.

When the sample 40 to the sample 50 are presented, decoding processing is first performed on the LibraryEffect3 in the track 1, then the LibraryEffect3 is presented, and after the LibraryEffect3 is presented, the ordinary haptics signals included in the sample 40 to the sample 50 are presented.

Example 3: The knowledge haptics signal includes time-sequence reusable haptics media, the time-sequence reusable haptics media is stored in a dynamic storage manner, and the time-sequence reusable haptics media is encapsulated into a sample entry of a track. On the premise, the data processing method for the haptics media provided in this application includes the following operations.

1. A service device may obtain the haptics media, and perform encoding processing on the haptics media, to obtain a bitstream of the haptics media; determine reusable haptics media in the haptics media, for example, identify haptics media that is repeatedly used for a plurality of times as the reusable haptics media; and then add presentation indication information of the reusable haptics media according to a property of the reusable haptics media. The presentation indication information of the reusable haptics media may include metadata information of the reusable haptics media. the reusable haptics media includes three knowledge haptics signals, namely, LibraryEffect1, LibraryEffect2, and LibraryEffect3. The metadata information of the reusable haptics media is as follows:
LibraryEffect1: @id=1; @group_id=1; @label=‘gunType1’
LibraryEffect2: @id=2; @group_id=1; @label=‘gunType1’
LibraryEffect3: @id=3; @group_id=2; @label=‘gunType2’

For the LibraryEffect1, @id=1 indicates that an identifier of the LibraryEffect1 is 1, @group_id=1 indicates that a group identifier of a group to which the LibraryEffect1 belongs is 1, and @label=‘gunType1’ indicates that a label of the LibraryEffect1 is ‘gunType1’. For the LibraryEffect2, @id=2 indicates that an identifier of the LibraryEffect2 is 2, @group_id=1 indicates that a group identifier of a group to which the LibraryEffect2 belongs is 1, and @label=‘gunType1’ indicates that a label of the LibraryEffect2 is ‘gunType1’. For the LibraryEffect3, @id=3 indicates that an identifier of the LibraryEffect3 is 3, @group_id=2 indicates that a group identifier of a group to which the LibraryEffect3 belongs is 2, and @label=‘gunType2’ indicates that a label of the LibraryEffect3 is ‘gunType2’.

2. The service device performs encapsulation processing on the bitstream of the haptics media and the presentation indication information of the reusable haptics media, to obtain a media file of the haptics media. Specifically, the haptics media includes time-sequence haptics media. the time-sequence haptics media includes the time-sequence reusable haptics media and another haptics media. the another haptics media includes ordinary time-sequence haptics media. the time-sequence haptics media is encapsulated as haptics media track (namely, the track 1). the haptics media track includes one or more samples. A reference knowledge haptics sample group and a knowledge haptics sample group are divided in the haptics media track, to form the media file of the haptics media. In this case, the presentation indication information of the reusable haptics media includes the sample entry, and the sample entry is configured for indicating a property of the time-sequence reusable haptics media. The presentation indication information of the reusable haptics media includes relationship indication information, the relationship indication information includes an entry of the reference knowledge haptics sample group, and the entry of the reference knowledge haptics sample group is configured for indicating that the another haptics media in the haptics media track depends on the time-sequence reusable haptics media in the haptics media track during presentation. The media file is as follows:
track 1: haptics media track; and
for the track 1, a sample of the reference reusable haptics media in the track 1 is identified through the reference knowledge haptics sample group.

AVSHapticsLibRefGroupEntry1: It is assumed that the AVSHapticsLibRefGroupEntry1 corresponds to a sample 10 to a sample 20.

{
num_refer_library_haptics=1;
refer_library_haptics_id=1; refer_library_group_id=1;
refer_library_label=‘gunType1’
}

AVSHapticsLibRefGroupEntry1 includes the sample 10 to the sample 20. num_refer_library_haptics=1 indicates that a quantity of knowledge haptics signals on which the sample 10 to the sample 20 in the ordinary haptics media track (namely, the track 1) depend is 1, refer_library_haptics_id=1 indicates that an identifier of the knowledge haptics signal on which the sample 10 to the sample 20 depend is 1, and refer_library_group_id=1 indicates that a group identifier of a group to which the knowledge haptics signal on which the sample 10 to the sample 20 depend is 1. refer_library_label=‘gunType1’ indicates that a label of a knowledge haptics signal on which the sample 10 to the sample 20 depend is gunType1.

AVSHapticsLibRefGroupEntry2: It is assumed that the AVSHapticsLibRefGroupEntry2 corresponds to a sample 15 to the sample 20.

{
num_refer_library_haptics=1;
refer_library_haptics_id=2; refer_library_group_id=1;
refer_library_label=‘gunType1’
}

AVSHapticsLibRefGroupEntry2 includes the sample 15 to the sample 20. num_refer_library_haptics=1 indicates that a quantity of knowledge haptics signals on which the sample 15 to the sample 20 in the ordinary haptics media track (namely, the track 1) depend is 1, refer_library_haptics_id=2 indicates that an identifier of the knowledge haptics signal on which the sample 15 to the sample 20 depend is 2, and refer_library_group_id=1 indicates that a group identifier of a group to which the knowledge haptics signal on which the sample 15 to the sample 20 depend is 1. refer_library_label=‘gunType1’ indicates that a label of a knowledge haptics signal on which the sample 15 to the sample 20 depend is gunType1.

AVSHapticsLibRefGroupEntry3: It is assumed that AVSHapticsLibRefGroupEntry3 corresponds to a sample 40 to a sample 50.

{
num_refer_library_haptics=1;
refer_library_haptics_id=3; refer_library_group_id=2;
refer_library_label=‘gunType2’
}

AVSHapticsLibRefGroupEntry3 includes the sample 40 to the sample 50. num_refer_library_haptics=1 indicates that a quantity of knowledge haptics signals on which the sample 40 to the sample 50 in the ordinary haptics media track (namely, the track 1) depend is 1, refer_library_haptics_id=3 indicates that an identifier of the knowledge haptics signal on which the sample 40 to the sample 50 depend is 3, and refer_library_group_id=2 indicates that a group identifier of a group to which the knowledge haptics signal on which the sample 40 to the sample 50 depend is 2. refer_library_label=‘gunType2’ indicates that a label of a knowledge haptics signal on which the sample 40 to the sample 50 depend is gunType2.

For the track 1, the sample of the reusable haptics media in the track 1 further needs to be identified through the knowledge haptics sample group, and it needs to be ensured that a sample to which the knowledge haptics signal belongs cannot be located behind a sample to which the ordinary haptics signal that depends on the knowledge haptics signal belongs.

AVSHapticsLibraryGroupEntry1: It is assumed that the AVSHapticsLibraryGroupEntry1 corresponds to a sample 10.

{
num_library_haptics=2;
{library_haptics_id=1; library_group_id=1; library_label=‘gunType1’}
{library_haptics_id=2; library_group_id=1; library_label=‘gunType1’}
}

num_library_haptics=2 indicates that a quantity of knowledge haptics signals included in the sample 10 is 2, library_haptics_id=1 and library_haptics_id=2 indicate that an identifier of one knowledge haptics signal in the sample 10 is 1, and an identifier of the other knowledge haptics signal is 2. library group_id=1 indicates that group identifiers of groups to which the two knowledge haptics signals in the sample 10 belong are 1, and library_label=‘gunType1’ indicates that labels of the two knowledge haptics signals in the sample 10 are gunType1.

AVSHapticsLibraryGroupEntry2: It is assumed that the AVSHapticsLibraryGroupEntry2 corresponds to a sample 40.

{
num_library_haptics=1;
{library_haptics_id=3; library_group_id=2; library_label=‘gunType2’}
}

num_library_haptics=1 indicates that a quantity of knowledge haptics signals included in the sample 40 is 1, and library_haptics_id=3 indicates that an identifier of the knowledge haptics signal in the sample 40 is 3. library_group_id=2 indicates that a group identifier of a group to which the knowledge haptics signal in the sample 40 belongs is 2, and library_label=‘gunType2’ indicates that a label of the knowledge haptics signal in the sample 40 is gunType2.

3. The service device transmits the media file F of the haptics media to a consumption device. The transmitting the media file F of the haptics media to a consumption device includes the following two types:

(1) The service device may directly transmit the complete media file F to the consumption device; and

(2) the service device may transmit one or more file segments Fs to the consumption device in a streaming manner. During streaming transmission, the service device needs to transmit description information of the presentation indication information of the reusable haptics media to the consumption device through transmission signaling. The consumption device may determine the presentation indication information of the reusable haptics media according to the description information of the presentation indication information, and obtain, according to the transmission signaling, an ordinary reusable haptics media and reusable haptics media on which the ordinary reusable haptics media depends. DASH signaling is used as an example. The description information includes a haptics information descriptor (namely, an AVSHapticsInfo descriptor), and knowledge haptics signals included in different media resources and another media resource depending on the knowledge haptics signal may be indicated through the AVSHapticsInfo descriptor. Because the reusable haptics media and the ordinary haptics media are located in the same media resource, the AVSHapticsInfo descriptor is as follows:

Representation1: {AVSHapticsInfo@non_timed_media_flag=0; @library_haptics_info=0}. AVSHapticsInfo@non_timed_media_flag=0 indicates that the Representation1 is a dynamic time-sequence media resource, library_haptics_info=0 indicates that the Representation1 includes an ordinary haptics signal, and the Representation1 does not depend on other media resources including knowledge haptics signals.

4. After obtaining the media file F or the file segment Fs, the consumption device may perform decapsulation processing on the media file F or the file segment Fs according to the presentation indication information of the reusable haptics media, to obtain a bitstream of the haptics media, decode the corresponding reusable haptics media and ordinary haptics media according to the association relationship that is between the reusable haptics media and the ordinary haptics media and that is indicated by the relationship indication information included in the presentation indication information, and present the decoded reusable haptics media and the ordinary haptics media.

(1) For the complete media file F, the consumption device learns, by parsing the AVSHapticsLibraryGroupEntry1 and the AVSHapticsLibraryGroupEntry2, that a sample of the knowledge haptics signal is included in the media file, and determines an association relationship between the ordinary haptics media and the reusable haptics media through the AVSHapticsLibRefGroupEntry. That is, when presenting the sample 10 to the sample 20 of the track 1, the consumption device may first decode samples including the LibraryEffect1 and the LibraryEffect2 in the haptics media track, present the LibraryEffect1 and the LibraryEffect2 after decoding, and then present the sample 10 to the sample 20 of the track 1.

When the sample 40 to the sample 50 of the track 1 are presented, the sample including the LibraryEffect3 in the haptics media track is first decoded, the LibraryEffect3 is presented after decoding, and then the sample 40 to the sample 50 of the track 1 are presented.

(2) For streaming transmission, the consumption device determines, through the description information of the presentation indication information of the reusable haptics media in the transmission signaling, that the Representation1 includes the ordinary haptics signal and does not depend on the other media resources including the knowledge haptics signals.

The consumption device may request a set of file segments Fs corresponding to the Representation1, parse the AVSHapticsLibraryGroupEntry and the AVSHapticsLibRefGroupEntry in the file segments Fs, and when learning that when file segments corresponding to the sample 10 to the sample 20 are presented, decoding processing is first performed on samples including the LibraryEffect1 and the LibraryEffect2, then the LibraryEffect1 and the LibraryEffect2 are presented, and after the LibraryEffect1 and the LibraryEffect2 are presented, the ordinary haptics signals included in the sample 10 to the sample 20 are presented.

When the file segments corresponding to the sample 40 to the sample 50 are presented, decoding processing is first performed on the sample including the LibraryEffect3, then the LibraryEffect3 is presented, and after the LibraryEffect3 is presented, the ordinary haptics signals included in the sample 40 to the sample 50 are presented.

Example 4: the reusable haptics media includes time-sequence reusable haptics media and another haptics media, the another haptics media includes ordinary time-sequence haptics media, and the time-sequence reusable haptics media is separately stored in a dynamic storage method and is located in a track different from that of the ordinary haptics media. On the premise, the data processing method for the haptics media provided in this application includes the following operations.

1. A service device may obtain the haptics media, and perform encoding processing on the haptics media, to obtain a bitstream of the haptics media; determine reusable haptics media in the haptics media, for example, identify haptics media that is repeatedly used for a plurality of times as the reusable haptics media; and then add presentation indication information of the reusable haptics media according to a property of the reusable haptics media. The presentation indication information of the reusable haptics media may include metadata information of the reusable haptics media. the reusable haptics media includes three knowledge haptics signals, namely, LibraryEffect1, LibraryEffect2, and LibraryEffect3. The metadata information of the reusable haptics media is as follows:
LibraryEffect1: @id=1; @group_id=1; @label=‘gunType1’
LibraryEffect2: @id=2; @group_id=1; @label=‘gunType1’
LibraryEffect3: @id=3; @group_id=2; @label=‘gunType2’

For the LibraryEffect1, @id=1 indicates that an identifier of the LibraryEffect1 is 1, @group_id=1 indicates that a group identifier of a group to which the LibraryEffect1 belongs is 1, and @label=‘gunType1’ indicates that a label of the LibraryEffect1 is ‘gunType1’. For the LibraryEffect2, @id=2 indicates that an identifier of the LibraryEffect2 is 2, @group_id=1 indicates that a group identifier of a group to which the LibraryEffect2 belongs is 1, and @label=‘gunType1’ indicates that a label of the LibraryEffect2 is ‘gunType1’. For the LibraryEffect3, @id=3 indicates that an identifier of the LibraryEffect3 is 3, @group_id=2 indicates that a group identifier of a group to which the LibraryEffect3 belongs is 2, and @label=‘gunType2’ indicates that a label of the LibraryEffect3 is ‘gunType2’.

2. The service device performs encapsulation processing on the bitstream of the haptics media and the presentation indication information of the reusable haptics media, to obtain a media file of the haptics media. the haptics media includes time-sequence haptics media, the time-sequence haptics media includes time-sequence reusable haptics media and another haptics media, and the another haptics media includes ordinary time-sequence haptics media. In this case, that the service device performs encapsulation processing on the bitstream of the haptics media and the presentation indication information of the reusable haptics media, to obtain a media file of the haptics media includes: @1) encapsulating the ordinary time-sequence haptics media as an ordinary haptics media track (namely, the track 1), where the ordinary haptics media track includes one or more samples; (2) encapsulating the time-sequence reusable haptics media as reusable haptics media track (namely, the track 2), where the reusable haptics media track includes one or more samples; dividing a knowledge haptics sample group in the reusable haptics media track; and dividing a reference knowledge haptics sample group in the ordinary haptics media track. In this case, the presentation indication information of the reusable haptics media includes an entry of the knowledge haptics sample group. The presentation indication information of the reusable haptics media includes relationship indication information, the relationship indication information includes an entry of the reference knowledge haptics sample group, and the entry of the reference knowledge haptics sample group is configured for indicating that the another haptics media in the haptics media track depends on the time-sequence reusable haptics media in the haptics media track during presentation. The relationship indication information further includes track reference of a preset type, and the track 1 and the track 2 are associated through the track reference of the preset type, to form the media file of the haptics media. The media file is as follows:
track 1: an ordinary haptics media track; and
track 2: The track 2 includes reusable haptics media tracks of the LibraryEffect1, the LibraryEffect2, and the LibraryEffect3.

For the track 1, a sample of the reference reusable haptics media in the track 1 is identified through the reference knowledge haptics sample group.

AVSHapticsLibRefGroupEntry1: It is assumed that the AVSHapticsLibRefGroupEntry1 corresponds to a sample 10 to a sample 20.

{
num_refer_library_haptics=1;
refer_library_haptics_id=1; refer_library_group_id=1;
refer_library_label=‘gunType1’
}

AVSHapticsLibRefGroupEntry1 includes the sample 10 to the sample 20. num_refer_library_haptics=1 indicates that a quantity of knowledge haptics signals on which the sample 10 to the sample 20 in the ordinary haptics media track (namely, the track 1) depend is 1, refer_library_haptics_id=1 indicates that an identifier of the knowledge haptics signal on which the sample 10 to the sample 20 depend is 1, and refer_library_group_id=1 indicates that a group identifier of a group to which the knowledge haptics signal on which the sample 10 to the sample 20 depend is 1. refer_library_label=‘gunType1’ indicates that a label of a knowledge haptics signal on which the sample 10 to the sample 20 depend is gunType1.

AVSHapticsLibRefGroupEntry2: It is assumed that the AVSHapticsLibRefGroupEntry2 corresponds to a sample 15 to the sample 20.

{
num_refer_library_haptics=1;
refer_library_haptics_id=2; refer_library_group_id=1;
refer_library_label=‘gunType1’
}

AVSHapticsLibRefGroupEntry2 includes the sample 15 to the sample 20. num_refer_library_haptics=1 indicates that a quantity of knowledge haptics signals on which the sample 15 to the sample 20 in the ordinary haptics media track (namely, the track 1) depend is 1, refer_library_haptics_id=2 indicates that an identifier of the knowledge haptics signal on which the sample 15 to the sample 20 depend is 2, and refer_library_group_id=1 indicates that a group identifier of a group to which the knowledge haptics signal on which the sample 15 to the sample 20 depend is 1. refer_library_label=‘gunType1’ indicates that a label of a knowledge haptics signal on which the sample 15 to the sample 20 depend is gunType1.

AVSHapticsLibRefGroupEntry3: It is assumed that AVSHapticsLibRefGroupEntry3 corresponds to a sample 40 to a sample 50.

{
num_refer_library_haptics=1;
refer_library_haptics_id=3; refer_library_group_id=2;
refer_library_label=‘gunType2’
}

AVSHapticsLibRefGroupEntry3 includes the sample 40 to the sample 50. num_refer_library_haptics=1 indicates that a quantity of knowledge haptics signals on which the sample 40 to the sample 50 in the ordinary haptics media track (namely, the track 1) depend is 1, refer_library_haptics_id=3 indicates that an identifier of the knowledge haptics signal on which the sample 40 to the sample 50 depend is 3, and refer_library_group_id=2 indicates that a group identifier of a group to which the knowledge haptics signal on which the sample 40 to the sample 50 depend is 2. refer_library_label=‘gunType2’ indicates that a label of a knowledge haptics signal on which the sample 40 to the sample 50 depend is gunType2.

For the track 2, the sample of the reusable haptics media in the track 2 further needs to be identified through the knowledge haptics sample group, and it needs to be ensured that a sample to which the reusable haptics media belongs cannot be located behind a sample to which the ordinary haptics media that depends on the reusable haptics media belongs.

AVSHapticsLibraryGroupEntry1: It is assumed that the AVSHapticsLibraryGroupEntry1 corresponds to a sample 10.

{
num_library_haptics=2;
{library_haptics_id=1; library_group_id=1; library_label=‘gunType1’}
{library_haptics_id=2; library_group_id=1; library_label=‘gunType1’}
}

num_library_haptics=2 indicates that a quantity of knowledge haptics signals included in the sample 10 is 2, library_haptics_id=1 and library_haptics_id=2 indicate that an identifier of one knowledge haptics signal in the sample 10 is 1, and an identifier of the other knowledge haptics signal is 2. library_group_id=1 indicates that group identifiers of groups to which the two knowledge haptics signals in the sample 10 belong are 1, and library_label=‘gunType1’ indicates that labels of the two knowledge haptics signals in the sample 10 are gunType1.

AVSHapticsLibraryGroupEntry2: It is assumed that the AVSHapticsLibraryGroupEntry2 corresponds to a sample 40.

{
num_library_haptics=1;
{library_haptics_id=3; library_group_id=2; library_label=‘gunType2’}
}

num_library_haptics=1 indicates that a quantity of knowledge haptics signals included in the sample 40 is 1, and library_haptics_id=3 indicates that an identifier of the knowledge haptics signal in the sample 40 is 3. library_group_id=2 indicates that a group identifier of a group to which the knowledge haptics signal in the sample 40 belongs is 2, and library_label=‘gunType2’ indicates that a label of the knowledge haptics signal in the sample 40 is gunType2.

The track 1 is associated with the track 2 through track reference of a type ‘ahlr’.

3. The service device transmits the media file F of the haptics media to a consumption device. The transmitting the media file F of the haptics media to a consumption device includes the following two types:

(1) The service device may directly transmit the complete media file F to the consumption device; and

(2) the service device may transmit one or more file segments Fs to the consumption device in a streaming manner. During streaming transmission, the service device needs to transmit description information of the presentation indication information of the reusable haptics media to the consumption device through transmission signaling. The consumption device may determine the presentation indication information of the reusable haptics media according to the description information of the presentation indication information, and obtain, according to the transmission signaling, an ordinary reusable haptics media and reusable haptics media on which the ordinary reusable haptics media depends. DASH signaling is used as an example. The description information includes a haptics information descriptor (namely, an AVSHapticsInfo descriptor), and knowledge haptics signals included in different media resources and another media resource depending on the knowledge haptics signal may be indicated through the AVSHapticsInfo descriptor. Because the reusable haptics media and the ordinary haptics media are located in the same media resource, the AVSHapticsInfo descriptor is as follows:

Representation1: The Representation1 corresponds to the track 1.
{AVSHapticsInfo@non_timed_media_flag=0; library_haptics_info=2; @dependencyId=2}

AVSHapticsInfo@non_timed_media_flag=0 indicates that the Representation1 is a dynamic time-sequence media resource, library_haptics_info=2 indicates that the Representation1 includes an ordinary haptics signal, and the Representation1 depends on another media resource including a knowledge haptics signal. @dependencyId=2 indicates that an identifier of the another media resource on which the Representation1 depends and that includes the knowledge haptics signal is 2 (namely, Representation2).

Representation2: The Representation2 corresponds to the track 2.
{AVSHapticsInfo@non_timed_media_flag=0; library_haptics_info=1}

AVSHapticsInfo@non_timed_media_flag=0 indicates that the Representation2 is a dynamic time-sequence media resource, and library_haptics_info=1 indicates that the Representation1 includes only the knowledge haptics signal.

4. After obtaining the media file F or the file segment Fs, the consumption device may perform decapsulation processing on the media file F or the file segment Fs according to the presentation indication information of the reusable haptics media, to obtain a bitstream of the haptics media, decode the corresponding reusable haptics media and ordinary haptics media according to the association relationship that is between the reusable haptics media and the ordinary haptics media and that is indicated by the relationship indication information included in the presentation indication information, and present the decoded reusable haptics media and the ordinary haptics media.

(1) For the complete media file F, the consumption device learns, by parsing the AVSHapticsLibraryGroupEntry1 and the AVSHapticsLibraryGroupEntry2, that a sample of the knowledge haptics signal is included in the media file, and determines an association relationship between the ordinary haptics media and the reusable haptics media through the AVSHapticsLibRefGroupEntry. That is, the consumption device may first decode the samples including the LibraryEffect1 and the LibraryEffect2 in the reusable haptics media track when presenting the sample 10 to the sample 20 of the track 1, present the LibraryEffect1 and the LibraryEffect2 after decoding, and then present the sample 10 to the sample 20 of the track 1.

When the sample 40 to the sample 50 of the track 1 are presented, the sample including the LibraryEffect3 in the reusable haptics media track is first decoded, the LibraryEffect3 is presented after decoding, and then the sample 40 to the sample 50 of the track 1 are presented after decoding.

(2) For streaming transmission, the consumption device determines, through the description information of the presentation indication information of the reusable haptics media in the transmission signaling, that the Representation1 includes the ordinary haptics signal and depends on the other media resources (namely, the Representation2) including the knowledge haptics signals.

The consumption device may request a set of file segments Fs corresponding to the Representation1, parse the AVSHapticsLibRefGroupEntry in the file segments Fs, and learn that when file segments corresponding to the sample 10 to the sample 20 are presented, the consumption device needs to first request the Representation2, request the Representation2 from the service device, then perform decoding processing on the LibraryEffect1 and the LibraryEffect2 in the Representation2, and present the LibraryEffect1 and the LibraryEffect2; and then, after presenting the LibraryEffect1 and the LibraryEffect2, present the ordinary haptics signals included in the sample 10 to the sample 20.

When the file segments corresponding to the sample 40 to the sample 50 are presented, decoding processing is first performed on the LibraryEffect3 in the Representation2, then the LibraryEffect3 is presented, and after the LibraryEffect3 is presented, the ordinary haptics signals included in the sample 40 to the sample 50 are presented.

Next, the data processing apparatus for the haptics media involved in the embodiments of this application is described.

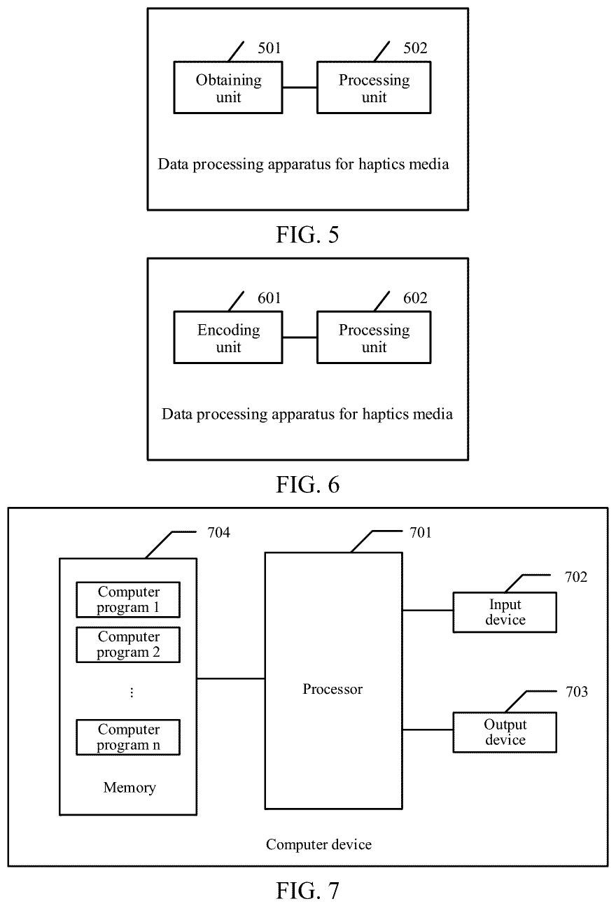

FIG. 5 is a schematic diagram of a structure of a data processing apparatus for haptics media according to an embodiment of this application. The data processing apparatus for the haptics media may be disposed in a computer device according to an embodiment of this application, and the computer device may be the consumption device mentioned in the foregoing method embodiments. The data processing apparatus for the haptics media shown in FIG. 5 may be a computer program (including program code) running in a computer device, and the data processing apparatus for the haptics media may be configured to perform some or all operations in the method embodiment shown in FIG. 3. Referring to FIG. 5, the data processing apparatus for the haptics media may include the following units:
an obtaining unit 501, configured to obtain a media file of haptics media, the haptics media including reusable haptics media, and the media file including a bitstream of the haptics media and presentation indication information of the reusable haptics media; and
a processing unit 502, configured to perform decoding processing on the bitstream of the haptics media based on the presentation indication information of the reusable haptics media, to present the reusable haptics media.

In specific implementation, the computer device (the consumption device) in this embodiment can perform the implementation provided in the foregoing operations in FIG. 3 through a built-in data processing apparatus thereof. For details, refer to the implementations provided in the foregoing operations and details are not described herein again.

In the embodiments of this application, a decoder side (a consumption device) of the haptics media may obtain the media file of the haptics media, the haptics media includes the reusable haptics media, and the media file includes the bitstream of the haptics media and the presentation indication information of the reusable haptics media; and perform decoding processing on the bitstream according to the presentation indication information of the knowledge haptics signal to present the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

FIG. 6 is a schematic diagram of a structure of a data processing apparatus for haptics media according to an embodiment of this application. The data processing apparatus for the haptics media may be disposed in a computer device according to an embodiment of this application, and the computer device may be the service device mentioned in the foregoing method embodiments. The data processing apparatus for the haptics media shown in FIG. 6 may be a computer program (including program code) running in a computer device, and the data processing apparatus for the haptics media may be configured to perform some or all operations in the method embodiment shown in FIG. 4. Referring to FIG. 6, the data processing apparatus for the haptics media may include the following units:
an encoding unit 601, configured to perform encoding processing on haptics media, to obtain a bitstream of the haptics media; and
a processing unit 602, configured to determine reusable haptics media in the haptics media, and add presentation indication information of the reusable haptics media, where
the processing unit 602 is further configured to perform encapsulation processing on the bitstream of the haptics media and the presentation indication information of the reusable haptics media, to obtain a media file of the haptics media.

In specific implementation, the computer device (the service device) in this embodiment can perform the implementation provided in the foregoing operations in FIG. 4 through a built-in data processing apparatus thereof. For details, refer to the implementations provided in the foregoing operations and details are not described herein again.

In the embodiments of this application, encoding processing is performed on the haptics media, to obtain the bitstream of the haptics media. Then, the reusable haptics media in the haptics media is determined, and the presentation indication information of the reusable haptics media is added. Encapsulation processing is performed on the bitstream of the haptics media and the presentation indication information of the reusable haptics media, to obtain the media file of the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side to accurately present the reusable haptics media, thereby improving a presentation effect of the reusable haptics media.

Next, a consumption device and a service device provided in the embodiments of this application are described.

Further, the embodiments of this application further provide a schematic diagram of a structure of a computer device. For the schematic diagram of the structure of the computer device, refer to FIG. 7; and the computer device may include: a processor 701, an input device 702, an output device 703, and a memory 704. The processor 701, the input device 702, the output device 703, and the memory 704 are connected through a bus. The memory 704 is configured to store a computer program. The computer program includes program instructions. The processor 701 is configured to execute the program instructions stored in the memory 704.

In an embodiment, the computer device may be the consumption device; and in this embodiment, the processor 701 performs the following operations by running executable program code in the memory 704:
obtaining a media file of haptics media, the haptics media including reusable haptics media, and the media file including a bitstream of the haptics media and presentation indication information of the reusable haptics media; and
performing decoding processing on the bitstream of the haptics media based on the presentation indication information of the reusable haptics media, to present the reusable haptics media.

In specific implementation, the computer device (the consumption device) in this embodiment can perform the implementation provided in the foregoing operations in FIG. 3 through a built-in computer program thereof. For details, refer to the implementations provided in the foregoing operations and details are not described herein again.

In the embodiments of this application, a decoder side (a consumption device) of the haptics media may obtain the media file of the haptics media, the haptics media includes the reusable haptics media, and the media file includes the bitstream of the haptics media and the presentation indication information of the reusable haptics media; and perform decoding processing on the bitstream according to the presentation indication information of the knowledge haptics signal to present the haptics media. It can be learnt from the foregoing solution that, an encoder side (a service device) in the embodiments of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

In another embodiment, the computer device may be the service device; and in this embodiment, the processor 701 performs the following operations by running executable program code in the memory 704:
performing encoding processing on haptics media, to obtain a bitstream of the haptics media;
determining reusable haptics media in the haptics media, and adding presentation indication information of the reusable haptics media; and
performing encapsulation processing on the bitstream of the haptics media and the presentation indication information of the reusable haptics media, to obtain a media file of the haptics media.

In specific implementation, the computer device (the service device) in this embodiment can perform the implementation provided in the foregoing operations in FIG. 4 through a built-in computer program thereof. For details, refer to the implementations provided in the foregoing operations and details are not described herein again.

In the embodiments of this application, a service device (an encoder side) performs encoding processing on the haptics media, to obtain a bitstream of the haptics media; determines reusable haptics media in the haptics media, and adds presentation indication information of the reusable haptics media; and performs encapsulation processing on the bitstream of the haptics media and the presentation indication information of the reusable haptics media, to obtain a media file of the haptics media. It can be learnt from the foregoing solution that, the encoder side (the service device) in the embodiment of this application may add the presentation indication information of the reusable haptics media to the media file of the haptics media in a process of encoding the haptics media, so that the encoder side (the service device) can indicate the reusable haptics media in the haptics media through the presentation indication information, and effectively indicate the decoder side (the consumption device) to accurately present the reusable haptics media, thereby improving a presentation effect of the reusable haptics media.

In addition, the embodiments of this application further provide a non-transitory computer-readable storage medium. The computer-readable storage medium stores a computer program, and the computer program includes program instructions. When executing the program instructions, the processor may perform the method in the embodiments corresponding to FIG. 3 and FIG. 4. Therefore, details are not repeated herein. For technical details that are not disclosed in the embodiments of the computer-readable storage medium of this application, refer to the method embodiments of this application. In an example, the program instructions may be deployed to be executed on a computer device, or deployed to be executed on a plurality of computer devices at the same location, or deployed to be executed on a plurality of computer devices that are distributed in a plurality of locations and interconnected by a communication network.

According to an aspect of this application, a computer program product is provided, including a computer program, the computer program being stored in a computer-readable storage medium. A processor of a computer device reads the computer program from the computer-readable storage medium and executes the computer program, to enable the computer device to perform the method in the foregoing embodiments corresponding to FIG. 3 and FIG. 4. Therefore, details are not repeated herein.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module/unit can be part of an overall module that includes the functionalities of the module/unit. The foregoing descriptions are merely some preferred embodiments of this application, and are not intended to limit the scope of this application. A person of ordinary skill in the art may understand and implement all or some procedures of the foregoing embodiments, and equivalent modifications made according to the claims of this application shall still fall within the scope of this application.

What is claimed is:

1. A method for processing haptics media performed by a computer device, the method comprising:
obtaining a media file of reusable haptics media, the media file comprising a bitstream of the reusable haptics media and presentation indication information of the reusable haptics media; and
performing decoding processing on the bitstream of the reusable haptics media based on the presentation indication information of the reusable haptics media, to present the reusable haptics media.

2. The method according to claim 1, wherein the presentation indication information of the reusable haptics media comprises metadata information of the reusable haptics media, and the metadata information is configured for indicating a property of the reusable haptics media; and
the metadata information comprises at least one of the following fields: an identifier field, a type field, a position field, a phase field, a basic signal type field, a composition signal field, a keyframe array field, a label field, a group identifier field, a repetition flag bit field, a repetition interval field, and a repetition count field, wherein
the label field is configured for indicating a label of a knowledge haptics signal comprised in the reusable haptics media; the group identifier field is configured for indicating a group identifier of a group to which the knowledge haptics signal in the reusable haptics media belongs; the repetition flag bit field is configured for indicating whether the knowledge haptics signal in the reusable haptics media needs to be repeated; the repetition interval field is configured for indicating a time interval between two times of repetition when the knowledge haptics signal in the reusable haptics media needs to be repeated; and the repetition count field is configured for indicating a repetition count of the knowledge haptics signal in the reusable haptics media.

3. The method according to claim 1, wherein the reusable haptics media comprises non-time-sequence reusable haptics media, the non-time-sequence reusable haptics media is encapsulated as reusable haptics media item in the media file, and the reusable haptics media item comprises one or more knowledge haptics signals of the non-time-sequence reusable haptics media.

4. The method according to claim 3, wherein the haptics media further comprises another haptics media other than the reusable haptics media, and the another haptics media comprises ordinary time-sequence haptics media and/or a non-time-sequence ordinary haptics media; and the presentation indication information of the reusable haptics media comprises relationship indication information, and the relationship indication information is configured for indicating an association relationship between the non-time-sequence reusable haptics media and the another haptics media; and
the relationship indication information comprises an entity group; the entity group comprises one or more entities, and the entity comprises the reusable haptics media item or the another haptics media; and the entity group is configured for indicating the another haptics media in the entity group to depend on haptics media item in the entity group during presentation.

5. The method according to claim 4, wherein the media file comprises N reusable haptics media items, and N is an integer greater than 1;
the relationship indication information comprises N entity groups, and each of the N entity groups comprises only one reusable haptics media item; and entity groups to which different reusable haptics media items belong are distinguished through identifiers of the entity groups; and
the entity group comprises an entity group identifier field, an entity quantity field, an entity identifier field, a knowledge haptics flag field, a knowledge haptics quantity field, a knowledge haptics identifier field, a knowledge haptics group identifier field, and a knowledge haptics label field, wherein
the entity group identifier field is configured for indicating the identifier of the entity group, and different entity groups have different identifiers;
the entity quantity field is configured for indicating a quantity of entities in the entity group;
the entity identifier field is configured for indicating an entity identifier in the entity group, and the entity identifier is the same as an item identifier of an item to which an identified entity belongs, or the entity identifier is the same as a track identifier of a track to which an identified entity belongs; and different entities have different entity identifiers;
the knowledge haptics flag field is configured for indicating whether a current entity comprises the knowledge haptics signal; when a value of the knowledge haptics flag field is a first preset value, it indicates that the current entity comprises the knowledge haptics signal; and when a value of the knowledge haptics flag field is a second preset value, it indicates that the current entity does not comprise the knowledge haptics signal;
the knowledge haptics quantity field is configured for indicating a quantity of knowledge haptics signals comprised in the current entity;
the knowledge haptics identifier field is configured for indicating an identifier of a current knowledge haptics signal in the current entity;
the knowledge haptics group identifier field is configured for indicating a group identifier of a group to which the current knowledge haptics signal belongs; and
the knowledge haptics label field is configured for indicating a label of the current knowledge haptics signal, wherein
the current entity is an entity that is in the entity group and that is being decoded; and the current knowledge haptics signal is a knowledge haptics signal that is in the current entity and that is being decoded.

6. The method according to claim 4, wherein the entity group comprises one or more reusable haptics media items in the media file, and each reusable haptics media item is a knowledge haptics entity in the entity group; and
the entity group comprises an entity group identifier field, an entity quantity field, an entity identifier field, a knowledge haptics quantity field, a knowledge haptics identifier field, a knowledge haptics group identifier field, a knowledge haptics label field, a reference knowledge haptics quantity field, and a referred entity identifier field, wherein
the entity group identifier field is configured for indicating an identifier of the entity group, and different entity groups have different identifiers;
the entity quantity field is configured for indicating a quantity of entities in the entity group;
the entity identifier field is configured for indicating an entity identifier in the entity group, and the entity identifier is the same as an item identifier of reusable haptics media item to which an identified entity belongs; and different entities have different entity identifiers;
the knowledge haptics quantity field is configured for indicating a quantity of knowledge haptics signals comprised in a current knowledge haptics entity in the entity group;
the knowledge haptics identifier field is configured for indicating an identifier of a current knowledge haptics signal in the current knowledge haptics entity;
the knowledge haptics group identifier field is configured for indicating a group identifier of a group to which the current knowledge haptics signal belongs;
the knowledge haptics label field is configured for indicating a label of the current knowledge haptics signal;
the reference knowledge haptics quantity field is configured for indicating a quantity of other entities that depend on the current knowledge haptics entity; and
the referred entity identifier field is configured for indicating an identifier of the another entity that depends on the current knowledge haptics entity, wherein
the current knowledge haptics entity is a knowledge haptics entity that is in the entity group and that is being decoded, and the current knowledge haptics signal is a knowledge haptics signal that is in the current knowledge haptics entity and that is being decoded.

7. The method according to claim 1, wherein the haptics media comprises time-sequence haptics media; the time-sequence haptics media comprises time-sequence reusable haptics media; the time-sequence haptics media is encapsulated as haptics media track in the media file, the haptics media track comprises one or more samples, and one sample comprises one or more haptics signals of the time-sequence haptics media; and the time-sequence reusable haptics media is encapsulated at a sample entry of the haptics media track;
the presentation indication information of the reusable haptics media comprises the sample entry, and the sample entry is configured for indicating a property of the time-sequence reusable haptics media; and the sample entry comprises a static knowledge haptics flag field, a knowledge haptics quantity field, a knowledge haptics identifier field, a knowledge haptics group identifier field, a knowledge haptics label field, a knowledge haptics length field, and a knowledge haptics content field, wherein
the static knowledge haptics flag field is configured for indicating whether the haptics media track comprises a static knowledge haptics signal; when a value of the static knowledge haptics flag field is a first preset value, it indicates that the haptics media track comprises the static knowledge haptics signal; and when a value of the static knowledge haptics flag field is a second preset value, it indicates that the haptics media track does not comprise the static knowledge haptics signal;
the knowledge haptics quantity field is configured for indicating a quantity of knowledge haptics signals comprised in the time-sequence reusable haptics media;
the knowledge haptics identifier field is configured for indicating an identifier of a current knowledge haptics signal in the time-sequence reusable haptics media;
the knowledge haptics group identifier field is configured for indicating a group identifier of a group to which the current knowledge haptics signal belongs;
the knowledge haptics label field is configured for indicating a label of the current knowledge haptics signal;
the knowledge haptics length field is configured for indicating a length of the current knowledge haptics signal; and
the knowledge haptics content field is configured for indicating content of the current knowledge haptics signal, wherein
the current knowledge haptics signal is a knowledge haptics signal that is in the time-sequence reusable haptics media and that is being decoded.

8. The method according to claim 1, wherein the haptics media comprises time-sequence haptics media; and the time-sequence haptics media is encapsulated as haptics media track in the media file;
the time-sequence haptics media comprises time-sequence reusable haptics media; the haptics media track comprises a knowledge haptics sample group, the knowledge haptics sample group comprises one or more samples, and any sample in the knowledge haptics sample group comprises one or more knowledge haptics signals in the time-sequence reusable haptics media;
the presentation indication information of the reusable haptics media comprises an entry of the knowledge haptics sample group; and the entry of the knowledge haptics sample group comprises: a knowledge haptics quantity field, a knowledge haptics identifier field, a knowledge haptics group identifier field, and a knowledge haptics label field, wherein
the knowledge haptics quantity field is configured for indicating a quantity of knowledge haptics signals comprised in a current sample in the knowledge haptics sample group; and the current sample is a sample that is in the knowledge haptics sample group and that is being decoded;
the knowledge haptics identifier field is configured for indicating an identifier of a current knowledge haptics signal in the current sample; and the current knowledge haptics signal is a knowledge haptics signal that is in the current sample and that is being decoded;
the knowledge haptics group identifier field is configured for indicating a group identifier of a group to which the current knowledge haptics signal belongs; and
the knowledge haptics label field is configured for indicating a label of the current knowledge haptics signal.

9. The method according to claim 7, wherein the time-sequence haptics media further comprises another haptics media other than the reusable haptics media, and the another haptics media comprises ordinary time-sequence haptics media; the time-sequence reusable haptics media and the another haptics media are encapsulated into a same haptics media track; and the presentation indication information of the reusable haptics media comprises relationship indication information, and the relationship indication information is configured for indicating an association relationship between the time-sequence reusable haptics media and the another haptics media;
the haptics media track comprises a reference knowledge haptics sample group, the reference knowledge haptics sample group comprises one or more samples in the haptics media track, and any sample in the reference knowledge haptics sample group depends on the knowledge haptics signal in the time-sequence reusable haptics media; and the relationship indication information comprises an entry of the reference knowledge haptics sample group, and the entry of the reference knowledge haptics sample group is configured for indicating that the another haptics media in the haptics media track depends on, during presentation, the time-sequence reusable haptics media in the haptics media track; and
the relationship indication information comprises a reference knowledge haptics quantity field, a reference knowledge haptics identifier field, a reference knowledge haptics group identifier field, and a reference knowledge haptics label field, wherein
the reference knowledge haptics quantity field is configured for indicating a quantity of knowledge haptics signals on which a current sample in the haptics media track depends; and the current sample is a sample that is in the haptics media track and that is being decoded;
the reference knowledge haptics identifier field is configured for indicating an identifier of a knowledge haptics signal on which the current sample depends;
the reference knowledge haptics group identifier field is configured for indicating a group identifier of a group to which the knowledge haptics signal on which the current sample depends belongs; and
the reference knowledge haptics label field is configured for indicating a label of the knowledge haptics signal on which the current sample depends, wherein
a decoding time point of a sample to which the time-sequence reusable haptics media in the haptics media track belongs is equal to or earlier than a decoding time point of a sample to which another haptics media that depends on the time-sequence reusable haptics media belongs.

10. The method according to claim 1, wherein the haptics media comprises time-sequence reusable haptics media and another haptics media that depends on the time-sequence reusable haptics media, and the another haptics media comprises ordinary time-sequence haptics media;
the time-sequence reusable haptics media is encapsulated into one or more reusable haptics media tracks in the media file, any reusable haptics media track comprises one or more samples, and any sample in any reusable haptics media track comprises one or more knowledge haptics signals in the time-sequence reusable haptics media; and any reusable haptics media track comprises a knowledge haptics sample group, and the knowledge haptics sample group is configured for identifying metadata information of the time-sequence reusable haptics media;
the ordinary time-sequence haptics media is encapsulated into one or more ordinary haptics media tracks in the media file; any ordinary haptics media track comprises one or more samples, and any sample in the any ordinary haptics media track comprises one or more haptics signals in the ordinary time-sequence haptics media; and the any ordinary media track comprises a reference knowledge haptics sample group, and the reference knowledge haptics sample group is configured for identifying metadata information of the ordinary time-sequence haptics media that depends on the reusable haptics media; and
the presentation indication information of the reusable haptics media comprises relationship indication information, the relationship indication information is configured for indicating an association relationship between the time sequence reusable haptics media and the another haptics media, and a decoding time point of a sample to which the time-sequence reusable haptics media belongs is equal to or earlier than a decoding time point of a sample to which another haptics media that depends on the time-sequence reusable haptics media belongs.

11. The method according to claim 10, wherein the relationship indication information comprises a track reference of a preset type, and the ordinary haptics media track and reusable haptics media track on which the ordinary haptics media track depends are associated through the track reference of the preset type; and
a sample in the ordinary haptics media track is aligned in time with a sample in the reusable haptics media track on which the ordinary haptics media track depends, and the aligned samples have a same decoding time point and a same presentation time point.

12. The method according to claim 1, wherein the haptics media is transmitted in a manner of streaming transmission; and the obtaining a media file of haptics media comprises:
obtaining transmission signaling of the haptics media, the transmission signaling comprising description information of the presentation indication information of the reusable haptics media; and
obtaining the media file of the haptics media according to the transmission signaling.

13. The method according to claim 12, wherein the transmission signaling is dynamic adaptive streaming signaling, and the description information comprises haptics media information descriptor in the dynamic adaptive streaming signaling;
the haptics media information descriptor is configured for identifying reusable haptics media resource comprising the knowledge haptics signal and an ordinary haptics media resource that depends on the reusable haptics media resource; and
the haptics media information descriptor is configured for describing media resources at at least one of the following levels: haptics media resource at a representation level and haptics media resource at an adaption set level.

14. The method according to claim 13, wherein the haptics media information descriptor comprises a haptics information element, a media resource type element, and a knowledge haptics information element, wherein
the haptics information element is configured for indicating metadata information of a current haptics media resource;
the media resource type element is configured for indicating a type of the current haptics media resource; when a value of the media resource type element is the first preset value, it indicates that the current haptics media resource is a static non-time-sequence media resource; and when a value of the media resource type element is the second preset value, it indicates that the current haptics media resource is a dynamic time-sequence media resource;
the knowledge haptics information element is configured for indicating a signal type in the current haptics media resource; when a value of the knowledge haptics information element is the first preset value, it indicates that the current haptics media resource comprises only the knowledge haptics signal; in this case, the haptics media information descriptor comprises a knowledge haptics identifier element, a knowledge haptics group identifier element, and a knowledge haptics label element; the knowledge haptics identifier element is configured for indicating an identifier of the knowledge haptics signal comprised in the current haptics media resource, and the knowledge haptics group identifier element is configured for indicating a group identifier of a group to which the knowledge haptics signal comprised in the current haptics media resource belongs; and the knowledge haptics label field is configured for indicating a label of the knowledge haptics signal comprised in the current haptics media resource;
when a value of the knowledge haptics information element is the second preset value, it indicates that the current haptics media resource comprises only an ordinary haptics signal, and the current haptics media resource does not depend on another media resource comprising the knowledge haptics signal;
when a value of the knowledge haptics information element is a third preset value, it indicates that the current haptics media resource comprises only the ordinary haptics signal, and the current haptics media resource depends on the another media resource comprising the knowledge haptics signal; in this case, the haptics media information descriptor further comprises a reference knowledge haptics identifier element, a reference knowledge haptics group identifier element, and a reference knowledge haptics label element; and the reference knowledge haptics identifier element is configured for indicating an identifier of a knowledge haptics signal on which the current haptics media resource depends;
the reference knowledge haptics group identifier field is configured for indicating a group identifier of a group to which the knowledge haptics signal on which the current haptics media resource depends belongs; and
the reference knowledge haptics label field is configured for indicating a label of the knowledge haptics signal on which the current haptics media resource depends, wherein
the current haptics media resource is haptics media that is in the bitstream and that is being decoded, and the current haptics media resource comprises any one or more of the following: haptics media track, haptics media item, or some samples in the haptics media track.

15. The method according to claim 13, wherein the haptics media information descriptor comprises a knowledge haptics flag element, and the knowledge haptics flag element is configured for indicating whether a current media resource comprises the knowledge haptics signal;
when a value of the knowledge haptics flag element is the first preset value, it indicates that the current media resource comprises the knowledge haptics signal; and
when a value of the knowledge haptics flag element is the second preset value, it indicates that the current media resource comprises an ordinary haptics signal; and in this case, if the current media resource depends on another haptics media resource comprising the knowledge haptics signal, the another haptics media resource comprising the knowledge haptics signal on which the current media resource depends is indicated through a dependency identifier field or an association identifier field.

16. The method according to claim 12, wherein the transmission signaling is intelligent media transmission signaling, and the description information comprises an asset group descriptor in the intelligent media transmission signaling; and
the asset group descriptor is configured for describing an ordinary haptics media resource, and indicating reusable haptics media resource on which the ordinary haptics media resource depends and that comprises the knowledge haptics signal.

17. The method according to claim 16, wherein the description information further comprises a media resource descriptor, and the media resource descriptor is configured for indicating metadata information of a corresponding haptics media resource;
the media resource descriptor comprises the knowledge haptics flag field; and the identifier haptics flag field is configured for indicating whether an asset group described by the asset group descriptor is a media resource comprising the knowledge haptics signal;
when a value of the identifier haptics flag field is the first preset value, it indicates that the asset group described by the asset group descriptor comprises only the media resource comprising the knowledge haptics signal; in this case, the media resource descriptor comprises a knowledge haptics quantity field, a knowledge haptics identifier field, a knowledge haptics group identifier field, and a knowledge haptics label field, wherein the knowledge haptics quantity field is configured for indicating a quantity of knowledge haptics signals comprised in the current media resource; the knowledge haptics identifier field is configured for indicating an identifier of the knowledge haptics signal comprised in the current media resource; the knowledge haptics group identifier field is configured for indicating a group identifier of a group to which the knowledge haptics signal comprised in the current media resource belongs; the knowledge haptics label field is configured for indicating a label of the knowledge haptics signal comprised in the current media resource; and the current media resource is a media resource that is being decoded; and
when a value of the identifier haptics flag field is the second preset value, it indicates that the asset group described by the asset group descriptor comprises an ordinary haptics signal and depends on the media resource comprising the knowledge haptics signal; in this case, the media resource descriptor comprises a reference knowledge haptics quantity field, a reference knowledge haptics identifier field, a reference knowledge haptics group identifier field, and a reference knowledge haptics label field; the reference knowledge haptics quantity field is configured for indicating a quantity of knowledge haptics signals on which the current media resource depends; the reference knowledge haptics identifier field is configured for indicating an identifier of a knowledge haptics signal on which the current media resource depends; the reference knowledge haptics group identifier field is configured for indicating a group identifier of a group to which the knowledge haptics signal on which the current media resource depends belongs; and the reference knowledge haptics label field is configured for indicating a label of the knowledge haptics signal on which the current media resource depends.

18. The method according to claim 1, wherein the haptics media further comprises the another haptics media other than the reusable haptics media, the presentation indication information of the reusable haptics media comprises the relationship indication information, and the relationship indication information is configured for indicating the association relationship between the non-time-sequence reusable haptics media and the another haptics media; and the performing decoding processing on the bitstream of the haptics media based on the presentation indication information of the reusable haptics media, to present the reusable haptics media comprises:
determining, according to the association relationship indicated by the relationship indication information, the another haptics media and reusable haptics media on which the another haptics media depends;
performing decoding processing on the another haptics media and the reusable haptics media; and
presenting the another haptics media and the reusable haptics media according to the association relationship.

19. A computer device, comprising:
a processor, being adapted to execute a computer program; and
a computer-readable storage medium, having a computer program stored therein, the computer program, when executed by the processor, causing the computer device to perform a method for processing haptics media including:
obtaining a media file of reusable haptics media, the media file comprising a bitstream of the reusable haptics media and presentation indication information of the reusable haptics media; and
performing decoding processing on the bitstream of the reusable haptics media based on the presentation indication information of the reusable haptics media, to present the reusable haptics media.

20. A non-transitory computer-readable storage medium, having a computer program stored therein, the computer program, when executed by a processor of a computer device, causing the computer device to perform a method for processing haptics media including:
obtaining a media file of reusable haptics media, the media file comprising a bitstream of the reusable haptics media and presentation indication information of the reusable haptics media; and
performing decoding processing on the bitstream of the reusable haptics media based on the presentation indication information of the reusable haptics media, to present the reusable haptics media.
